(19) United States
(12) Patent Application Publication
(10) Pub. No.: US 2025/0106045 A1
(43) Pub. Date: Mar. 27, 2025

(54) TERMINAL, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Teruyoshi FUJIWARA, Toyota-shi (JP); Iwao NITTA, Nagoya-shi (JP); Ryota SUZUKI, Ikeda-shi (JP)

(73) Assignee: TOYOTA JIDOSHA KABUSHIKI KAISHA, Toyota-shi (JP)

(21) Appl. No.: 18/824,439

(22) Filed: Sep. 4, 2024

(30) Foreign Application Priority Data
Sep. 22, 2023 (JP) 2023-159245

(51) Int. Cl. H04L 9/32

(52) U.S. Cl. CPC H04L 9/3268

(57) ABSTRACT

A terminal of a first target that is one of a mobility and a user has a controller. The controller provides electronic information to another terminal of a second target that is the other of the mobility and the user. The controller obtains an electronic signature of the second target and an electronic certificate of the second target from the other terminal. The controller verifies the validity of the electronic certificate of the second target using a public key of a certificate authority and verifies the validity of the electronic signature of the second target using a public key of the second target. In response to the success of the verification of the validity of the electronic certificate and the electronic signature, the controller sends a request to set a correspondence relationship between the first target and the second target to a management server.

### CROSS REFERENCE TO THE RELATED APPLICATION

This application claims the benefit of Japanese Patent Application No. 2023-159245, filed on Sep. 22, 2023, which is hereby incorporated by reference herein in its entirety.

### BACKGROUND

### Technical Field

The present disclosure relates to a terminal, an information processing method, and a program.

### Description of the Related Art

Patent Literature 1 cited in the citation list below describes a fee collection system for collecting fees for services from users of vehicles using cards or other media. Specifically, the fee collection system described in Patent Literature 1 is configured to bill the user of a rental car for a highway toll with the rental car based on links between the ID of an ETC (Electronic Toll Collection System) card, the provider of the rental car service, the date and time of use of the rental car, and the user of the rental car (billing information, registration information, payment information, and use information).

### CITATION LIST

### Patent Literature

Patent Literature 1: Japanese Patent Application Laid-Open No. 2022-140747

### SUMMARY

An object of the present disclosure is to provide technology that is effective in tracking users' use of mobilities with assured security.

A terminal according to a first aspect of the present disclosure is a terminal associated with a first target that is one of a mobility and a user, comprising a controller including at least one processor, the controller being configured to execute the processing of:
providing electronic information to another terminal associated with a second target that is the other of the mobility and the user;
obtaining an electronic signature of the second target generated using the electronic information, an electronic certificate of the second target issued by a certificate authority, and an identifier of the second target from the other terminal;
verifying the validity of the obtained electronic certificate using a public key of the certificate authority;
verifying the validity of the obtained electronic signature using a public key of the second target contained in the electronic certificate; and
in response to the success of the verification of the validity of the electronic certificate and the electronic signature, sending a request to set a correspondence relation between an identifier of the first target and the identifier of the second target to a management server.

An information processing method according to a second aspect of the present disclosure comprises the following processing performed by a terminal associated with a first target that is one of a mobility and a user:
providing electronic information to another terminal associated with a second target that is the other of the mobility and the user;
obtaining an electronic signature of the second target generated using the electronic information, an electronic certificate of the second target issued by a certificate authority, and an identifier of the second target from the other terminal;
verifying the validity of the obtained electronic certificate using a public key of the certificate authority;
verifying the validity of the obtained electronic signature using a public key of the second target contained in the electronic certificate; and
in response to the success of the verification of the validity of the electronic certificate and the electronic signature, sending a request to set a correspondence relation between an identifier of the first target and the identifier of the second target to a management server.

A non-transitory storage medium storing a program according to a third aspect of the present disclosure, the program is configured to cause a terminal associated with a first target that is one of a mobility and a user to execute the processing of:
providing electronic information to another terminal associated with a second target that is the other of the mobility and the user;
obtaining an electronic signature of the second target generated using the electronic information, an electronic certificate of the second target issued by a certificate authority, and an identifier of the second target from the other terminal;
verifying the validity of the obtained electronic certificate using a public key of the certificate authority;
verifying the validity of the obtained electronic signature using a public key of the second target contained in the electronic certificate; and
in response to the success of the verification of the validity of the electronic certificate and the electronic signature, sending a signal to set a correspondence relation between an identifier of the first target and the identifier of the second target to a management server.

In another aspect, the present disclosure may be construed to disclose a non-transitory storage medium that stores the above program.

According to the present disclosure, there is provided technology that is effective in tracking users' use of mobilities with assured security.

### BRIEF DESCRIPTION OF THE DRAWINGS

FIG. 1 is a diagram schematically illustrating an example situation where the technology disclosed herein is applied.

FIG. 2 is a diagram schematically illustrating an example situation where the technology disclosed herein is applied.

FIG. 3 is a diagram schematically illustrating an example of the hardware configuration of a management server according to an embodiment.

FIG. 4 is a diagram schematically illustrating an example of the hardware configuration of a first server according to the embodiment.

FIG. 5 is a diagram schematically illustrating an example of the hardware configuration of a second server according to the embodiment.

FIG. 6 is a diagram schematically illustrating an example of the hardware configuration of a first terminal according to the embodiment.

FIG. 7 is a diagram schematically illustrating an example of the hardware configuration of a second terminal according to the embodiment.

FIG. 8 is a diagram schematically illustrating an example of the software configurations of the apparatuses according to the embodiment.

FIG. 9 schematically illustrates an example of link information according to the embodiment.

FIG. 10 schematically illustrates an example of first target information according to the embodiment.

FIG. 11 schematically illustrates an example of second target information according to the embodiment.

FIG. 12 is a sequence diagram illustrating an example of the procedure of setting a link according to the embodiment.

FIG. 13 is a diagram schematically illustrating an example situation where the technology disclosed herein is applied according to a modification.

FIG. 14 is a diagram schematically illustrating an example of the hardware configuration of a third terminal according to the modification.

FIG. 15 is a diagram schematically illustrating an example of the software configurations of the apparatuses according to the modification.

FIG. 16 schematically illustrates an example of second target information according to the modification.

FIG. 17 schematically illustrates an example of link information according to the modification.

FIG. 18 is a diagram schematically illustrating an example situation where the technology disclosed herein is applied according to a second modification.

### DESCRIPTION OF THE EMBODIMENTS

The system described in Patent Literature 1 allows users to pay highway tolls through the ETC even when they do not carry their own ETC cards. However, the inventors of the technology disclosed herein have found the following problem with the prior art system.

With the growing diversity of MaaS (Mobility as a Service), the need for tracking the use of mobilities by users is expected to arise in order to increase the convenience such as payment efficiency with assured security. When the prior art system is examined in this regard, taking as an example a situation where a user rents a rental car, the prior art system can hold an association between the user and the date and time of use as usage information in accordance with the rental contract or the reservation for rental. However, since the date and time of use depends on the contract or the reservation, the usage information is not always consistent with the actual use of the rental car by the user. In the case of vehicles that are used without a contract or a reservation, as may be the case with private cars and company cars, usage information is not generated at all. Therefore, it is difficult for the prior art system to track the use of a mobility by a user with assured security. Situations in which this problem occurs is not limited to situations where a car is used. Similar problems can occur in situations where a mobility other than a car (e.g., an aircraft or a ship) is used and situation where multiple types of mobilities are used. Moreover, similar problems can occur in situations where anything other than a mobility is used.

To address the above problem, a terminal according to the first aspect of the present disclosure is configured as a terminal associated with a first target that is one of a mobility and a user, comprising a controller configured to execute the processing of, providing electronic information to another terminal associated with a second target that is the other of the mobility and the user, obtaining an electronic signature generated using the electronic information, an electronic certificate of the second target issued by a certificate authority, and an identifier of the second target from the other terminal, verifying the validity of the obtained electronic certificate using a public key of the certificate authority, verifying the validity of the obtained electronic signature using a public key of the second target contained in the electronic certificate, and in response to the success of the verification of the validity of the electronic certificate and the electronic signature, sending a request to set a correspondence relation between an identifier of the first target and the identifier of the second target to a management server.

In a mode, the terminal associated with the first target (which will also be referred to as the first terminal hereinafter) may provide the electronic information to the other terminal associated with the second target (which will also be referred to as the second terminal hereinafter) in response to the establishment of a usage relationship between the mobility and the user. The establishment of a usage relationship between the mobility and the user means that the user starts to use the mobility. For example, the expression “the user starts to use the mobility” can mean that the user gets in the mobility, that the user starts to rent the mobility, and that the user enters a ticket gate of the mobility. The electronic information may be a random number generated by the controller of the first terminal or a time stamp.

Upon receiving the electronic information provided from the first terminal, the second terminal generates an electronic signature associated with the second target using the received electronic information. In a mode, the second terminal may generate the electronic signature of the second target by encrypting specific information containing the electronic information and the identifier of the second target using a private key of the second target associated with the public key. The electronic signature of the second target generated by the second terminal is provided to the first terminal with the electronic certificate of the second target issued by the certificate authority and the identifier of the second target.

The data exchange between the first terminal and the second terminal may be performed through wireless or cable data communication or by other method such as reading a two-dimensional code.

Upon receiving the electronic signature of the second target, the electronic certificate of the second target, and the identifier of the second target, the first terminal verifies the validity of the electronic certificate of the second target using a public key of the certificate authority. In a mode, the process of verifying the validity of the electronic certificate of the second target may include decrypting an electronic signature of the certificate authority contained in the electronic certificate using the public key of the certificate authority, verifying the validity of the decrypted information of the electronic signature of the certificate authority using the public key of the second target and owner's identification information of the second target contained in the electronic certificate, and determining whether the electronic certificate is valid. The verification of the validity of the second target may be performed by an external server that has the public key of the certificate authority. In a mode, the certificate authority is a third-party organization that performs tasks related to certifications such as the issuance of the electronic certificate of the second target.

The controller of the first terminal verifies the validity of the electronic signature of the second target using the public key of the second target contained in the electronic certificate of the second target. In a mode, the process of verifying the validity of the electronic signature of the second target may include decrypting the electronic signature of the second target using the public key of the second target contained in the electronic certificate of the second target, and verifying the decrypted information of the electronic signature of the second target with the specific information. If the verification of the decrypted information of the electronic signature of the second target with the specific information succeeds, it is verified that the electronic signature of the second target was generated using the private key of the second target (i.e. the private key associated with the public key of the second target contained in the electronic certificate of the second target) and the electronic information provided by the first terminal. This means that the provider of the electronic signature of the second target has the private key of the second target, and that the provider of the electronic information is consistent with the provider of the electronic signature of the second target. Then, the consistent of the provider of the electronic signature of the second target with the second target authenticated by the certificate authority is assured. Therefore, if the verification of the decrypted information of the electronic signature of the second target with the specific information succeeds, the controller of the first target determines that the electronic signature of the second target is valid.

The order of the validity verification of the electronic certificate of the second target and the validity verification of the electronic signature of the second target may be arbitrary. In a mode, the validity of the electronic signature of the second target may be verified after the validity of the electronic certificate of the second target is verified. In another mode, the validity of the electronic certificate of the second target may be verified after the validity of the electronic signature of the second target is verified. In still another mode, the validity verification of the electronic certificate of the second target and the validity verification of the electronic signature of the second target may be performed at least partially in parallel.

The success of the verification of the validity of the electronic certificate of the second target and the electronic signature of the second target means the assured authenticity of the second target. Therefore, when the verification of the validity of the electronic certificate of the second target and the electronic signature of the second target succeeds, the controller of the first terminal sends a request to set a correspondence relation (Linking) between the identifier of the first target and the identifier of the second target to a management server. In response to this, the management server sets a correspondence relation (Linking) between the identifier of the first target and the identifier of the second target. A record of the set link makes it possible to track the usage relationship between the first target and the second target.

As above, according to the first aspect of the present disclosure, a correspondence relation (Linking) between the identifier of the first target and the identifier of the second target is allowed to be set on condition that the authenticity of the second target is assured. Therefore, it is possible to track the usage relationship between the first target and the second target with assured security.

In other aspects, the present disclosure may be construed as a disclosure of an information processing method by which a computer executes the processing of the first terminal described above, a program configured to cause a computer to execute the processing of the first terminal described above, and a non-transitory storage medium that stores such a program. The non-transitory storage medium refers to a medium that is readable by machines such as computers and adapted to store information such as programs by electrical, magnetic, optical, or chemical effects. In an aspect, the present disclosure may be construed as a disclosure of the second terminal or the management server related to the first terminal according to the above description. In other aspects, the present disclosure may be construed as a disclosure of an information processing method related to the second terminal or the management server, a program related thereto, and a non-transitory storage medium that stores such a program.

In the following, an embodiment of the technology disclosed herein will be described with reference to the drawings. The features of the following embodiment are illustrative, and the embodiment described here is merely an example in every aspect. Various improvements and modifications may be made without departing from the scope of the present disclosure. When implementing the disclosed technology, suitable concrete features may be adopted according to the mode of implementation. While data related to the embodiment is described in natural language, it is specified in further detail by computer-recognizable artificial language, commands, parameters, and machine language.

### EMBODIMENT

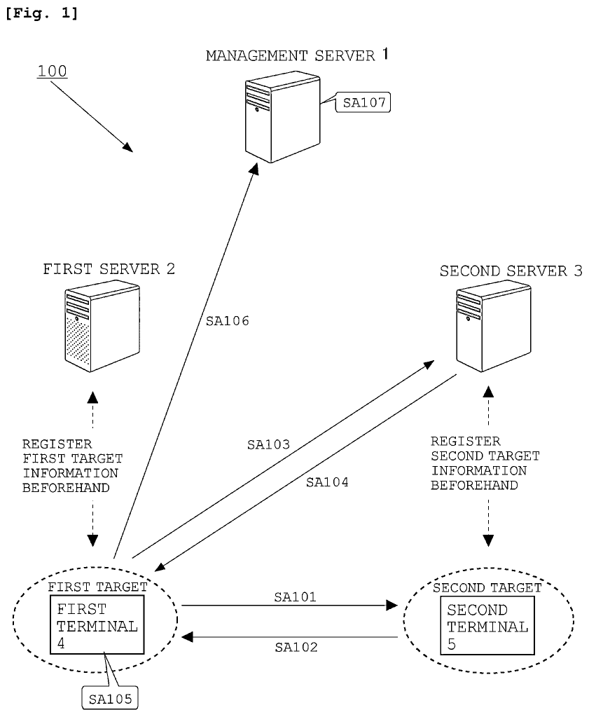

FIG. 1 is a diagram schematically illustrating an example situation where the technology disclosed herein is applied. A management system 100 according to an embodiment includes a management server 1, a first server 2, a second server 3, a first terminal 4, and a second terminal 5. The management server 1 is one or more computers that are configured to record an association (Linking) between a first target and a second target. The first server 2 is one or more computers that are configured to perform certification of the first target. The second server 3 is one or more computers that are configured to perform certification of the second target. The first server 2 and the second server 3 may also be respectively referred to as the certification server and the ID (identification) server. At least one of the first server 2 and the second server 3 may be provided by a third-party organization such as a certificate authority, a public agency, an independent organization, or a business entity (e.g., a manufacturer or a service provider). The first terminal 4 is a computer associated with the first target, which corresponds to “the terminal” according to the present disclosure. The second terminal 5 is a computer associated with the second target, which corresponds to “the other terminal” according to the present disclosure.

In this embodiment, when a usage relationship is established between the first target and the second target, data exchange is carried out between the first terminal 4 associated with the first target and the second terminal 5 associated with the second target (steps SA101 and SA102). In the illustrative case in FIG. 1, the first terminal provides electronic information to the second terminal 5 (step SA101). The second terminal 5 receives the electronic information provided by the first terminal 4, and then encrypts specific information that contains the aforementioned electronic information and an identifier of the second target (which will also be referred to as the “second identifier” hereinafter) using a private key of the second target to generate an electronic signature of the second target. The second terminal 5 provides the electronic signature of the second target generated as above, the second identifier of the second target, and an electronic certificate of the second target to the first terminal 4 (step SA102).

The first terminal 4 receives the electronic signature of the second target, the second identifier, and the electronic certificate of the second target, and then sends the second identifier and the electronic certificate of the second target to the second server 3, thereby requesting the second server 3 to verify the validity of the second identifier and the electronic certificate of the second target (step SA103). Upon receiving the above request, the second server 3 verifies the validity of the second identifier and the electronic certificate of the second target, and sends the result of the verification to the first terminal 4 (step SA104).

The first terminal 4 verifies the validity of the electronic signature of the second target received from the second terminal 5 (step SA105). The verification of the validity of the electronic signature of the second target is performed using a public key of the second target contained in the electronic certificate of the second target, the identifier of the second target provided from the second target, and the electronic information provided from the first terminal 4 to the second terminal 5 in step SA101.

In the illustrative case in FIG. 1, the validity of the electronic signature of the second target is verified after the validity of the electronic certificate of the second target is verified. However, the order of the validity verification of the electronic certificate of the second target and the validity verification of the electronic signature of the second target may be arbitrary.

When the verification of the validity of the electronic certificate, the second identifier, and the electronic signature of the second target succeeds, the first terminal 4 sends an identifier of the first target (which will also be referred to as “the first identifier” hereinafter) and the second identifier to the management server 1, thereby requesting the management server 1 to set a correspondence relation (Linking) between the first identifier and the second identifier (step SA106).

Upon receiving the request to set a correspondence relation (Linking) between the first identifier and the second identifier, the management server 1 sets a correspondence relation (Linking) between the first identifier and the second identifier (step SA107). In a mode, the management server 1 generates link information that indicates the setting of a correspondence relation (Linking) between the first identifier and the second identifier and records the generated link information. The management server 1 may return the result of this link processing to at least one of the first terminal 4 and the second terminal 5. The series of processing from the data exchange between the first terminal 4 and the second terminal 5 to the setting of the link may be performed on a real-time basis in accordance with the establishment of the usage relationship. The set link (correspondence relation) may be dissolved, when necessary, in accordance with the dissolution of the usage relationship between the first target and the second target. Establishing an association between the first identifier and the second identifier may be treated as setting a correspondence relation (Linking) between the first target and the second target.

When the management server 1 receives a request to set a correspondence relation (Linking) between the first identifier and the second identifier, the management server 1 may perform the certification of the first target through the first server 2, and set a correspondence relation (Linking) between the first identifier and the second identifier on condition that the certification succeeds.

As above, in the system according to the embodiment, the authenticity of the second target is verified in response to the setting of a correspondence relation between the first target and the second target (steps SA101-SA105). This is expected to ensure security. When the authenticity verification of the second target succeeds, a correspondence relation (Linking) between the first identifier and the second identifier is set (steps SA106-SA107). A record of this set link makes it possible to track the usage relationship between the first target and the second target. Therefore, the system according to the embodiment can track the usage relationship between the first target and the second target with assured security.

### (Targets)

The first and second targets are not specifically limited, but may be any targets between which a usage relationship can be established. They may be chosen appropriately depending on the mode of implementation. The first target and the second target may be any things including physical objects and human or other living beings. The targets may also include virtual things. The establishment of a usage relationship can mean the establishment of an actual or virtual relationship between at least two things. For example, a usage relationship is established when one thing uses the other, when one owns the other, when one is coupled to the other, or when one is connected to the other. The management system 100 disclosed herein can be used in any situation in which an association between two or more things is to be tracked.

### (Terminal)

The first terminal 4 and the second terminal 5 are respectively associated with the first target and the second target. The relationship between the first terminal 4 and the first target and the relationship between the second terminal 5 and the second target are not specifically limited, but may be chosen appropriately depending on the mode of implementation. For example, one of the first terminal 4 and the second terminal may be carried by the target associated therewith. Alternatively, one of the first terminal 4 and the second terminal 5 may be provided on the target associated therewith. The expression “the terminal is provided on the target” can refer to not only situations in which the terminal is permanently installed in the target but also situations in which the terminal is temporarily placed in the target while the target is used. Furthermore, the expression “the terminal is provided on the target” can also refer to situations in which the terminal is carried by the user of the target. One of the first terminal 4 and the second terminal 5 can be the associated target itself.

### (Identifier)

The first identifier and the second identifier are data used to identify the respective target. The first identifier and the second identifier may be any identifiers that can identify the respective targets, and their data format and structure are not specifically limited. Various data formats and structures of the first and second identifiers may be adopted according to the mode of implementation. For example, the first and second identifiers may be character strings including numerals, letters, etc.

The first identifier and the second identifier may be obtained in various manners. For example, at least one of the first and second identifiers may be stored beforehand in the terminal associated therewith. Alternatively, at least one of the first and second identifiers may be obtained by a device such as an input device or a sensor. For example, at least one of the first and second identifiers may be obtained with an input entered through the input device. At least one of the first and second identifiers may be converted into a code, and at least one of the first and second identifiers may be obtained by reading (or decoding) the code.

### (First and Second Servers)

Each of the first server 2 and the second server 3 may be constituted by one or more server apparatuses. The first server 2 and the second server 3 may be configured to manage target information concerning the respective targets and to perform the certification of the respective target in response to a request. The target information concerning the respective target may be stored in one or more storage devices provided in and/or externally of the first server 2 and the second server 3.

The target information managed by the first server 2 and the second server 3 may include information unique to the respective targets. In the system according to the embodiment, the target information managed by the second server 3 includes information used to certify the second target. The information used to certify the second target may be registered beforehand at a certain time before a request to set a link is made (e.g., at the time when an account of the second target is created).

Whether the certification of the second target succeeds or not is determined by verifying the validity of the electronic certificate of the second target received from the first terminal 4 and verifying information contained in the electronic certificate of the second target with already-registered information that is linked with the second identifier received from the first terminal 4. The method of the latter verification may be chosen appropriately according to the mode of implementation. In a simple mode, the success or the failure of the certification may be determined according to whether or not the information contained in the electronic certificate of the second target is consistent with the already-registered information linked with the second identifier. In another mode, the success or the failure of the certification may be determined based on the degree of agreement of the information contained in the electronic certificate of the second target and the already-registered information linked with the second identifier. This verification may use a trained model generated through machine learning. In the verification process, the already-registered information linked with the second identifier and the information contained in the electronic certificate of the second target may be compared directly, or indirectly after converting them into features.

Units of information managed by the first server 2 and the second server 3 are not specifically limited, but may be determined appropriately depending on the mode of implementation. For example, the information managed by the first server 2 and the second server 3 may be managed either in a lumped (or collective) manner or in a distributive (or separative) manner on a group-by-group basis. The server apparatuses that constitute the first server 2 and the second server 3 may be provided by one or more operating organizations (or entities). At least one of the first server 2 and the second server 3 may be provided by a plurality of operating organizations. In the case where the first server 2 and the second server 3 are provided by a plurality of operating organizations, the information managed by them may be either shared (in other words, managed collectively) or managed in a distributive manner among the operating organizations.

### (Management Server)

The management server 1 may be constituted by one or more server apparatuses. The management server 1 according to the present disclosure is configured to record information on the setting and the dissolution of a correspondence relationship between the first target and the second target as link information. The link information may be stored in one or more storage devices provided in and/or externally of the management server 1.

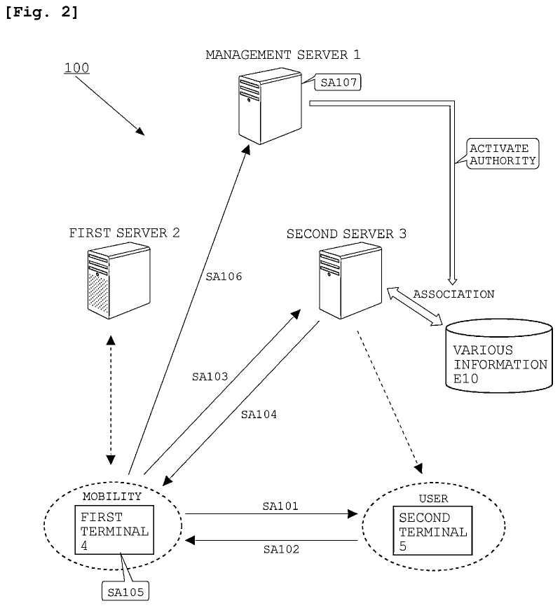

The link information recorded by the management server 1 may be used in various situations. For example, the link information may be used to track a usage relationship between the first target and the second target. For example, the link information may be used to allow an authority linked with either one of the first target and the second target to be exercised by the other while a set correspondence relation between the first target and the second target is present. In other words, the link information may be used to enable the exercise of an authority of either one of the first target and the second target by the other according to the link between the first target and the second target (see FIG. 2 described later).

### (Process of Checking Continuation of Usage)

The management server 1 may send a notification indicating the result of the link processing to at least one of the first terminal 4 and the second terminal 5. The route of sending the notification is not specifically limited, but may be determined appropriately depending on the mode of implementation. In a mode, the management server 1 may directly notify at least one of the first terminal 4 and the second terminal 5 of the result. In another mode, the management server 1 may indirectly notify at least one of the first terminal 4 and the second terminal 5 of the result through an external computer such as the first server 2 and/or the second server 3.

After setting the correspondence relation between the first target and the second target, the management server 1 may further perform processing for checking whether the association still continues or not (checking process). The method of executing the checking process may be chosen appropriately depending on the mode of implementation.

In a mode, when at least one of the first and second targets is a user (as in the case illustrated in FIG. 2 described later), the management server 1 may indirectly send a checking notification that contains an operation element to at least one of the first terminal 4 and the second terminal 5. For example, the operation element may be a confirm button, a reply button, or a link. The destination of the checking notification may not necessarily be associated with the user. In the later-described case illustrated in FIG. 2, the management server 1 may send the checking notification to at least one of the first terminal 4 and the second terminal 5. The destination of the checking notification may be either the same as or different from the destination of the notification of the result of the link processing. The checking notification may be configured in such a way as to directly or indirectly return a response to the management server 1 according to the user's operation performed on the operation element. If the management server 1 receives a reply caused by an operation of the operation element performed during a predetermined period, the management server 1 may determine that the association still continues. If the management server 1 does not receive a reply during the predetermined period, the management server 1 may determine that the association does not continue any longer (namely, has been discontinued).

In another mode, in the case where the association between the first target and the second target in the real world is to be tracked, the first terminal 4 and the second terminal 5 may be equipped with a positioning module, such as a GPS (Global Positioning Satellite) module or a GNSS (Global Navigation Satellite System) module. The first terminal 4 may determine the current location of the first target (first terminal 4) using its positioning module, and the second terminal 5 may determine the current location of the second target (second terminal 5) using its positioning module. The first terminal 4 and the second terminal 5 may send the current locations of the respective targets determined in this way to the management server 1 directly or indirectly via an external computer (e.g., first server 2 or the second server 3). The management server 1 may determine whether the association still continues or not based on whether the current locations of the respective targets it has received are close enough to satisfy a predetermined condition of usage relationship (e.g., a user as one of the first target and the second target is in a mobility as the other). Specifically, if the current locations of the respective targets are close enough to satisfy the predetermined condition, the management server 1 may determine that the association still continues, and if not, the management server 1 may determine that the association does not continue any longer. In the case this mode is adopted, the management server 1 may store the obtained information on the current locations of the respective targets in association with the link information. This allows the management server 1 to track the history of travel of the targets together with the association between the targets. The process that has been described in the foregoing may, at least partially, be executed by a computer other than the management server 1.

If it is determined that the association still continues, the management server 1 may maintain the set correspondence relationship. In contrast, if it is determined that the association does not continue any longer, the management server 1 may dissolve the association. The management server 1 may be configured to update the state of the correspondence relationship by iteratively executing the checking process at regular or irregular intervals during the period from the setting of the correspondence relationship to the dissolution of the the correspondence relationship.

### (Dissolution of Link)

In an operational example according to the embodiment, the management server 1 may be configured to dissolve the association when it receives a request for dissolution from at least one of the first terminal 4 and the second terminal 5 or when a predetermined condition for dissolution is met.

### (1) Dissolution Request

In a mode, a request for the dissolution of the link includes at least one of the first identifier and the second identifier. In a simple case, the first terminal 4 may send a dissolution request that contains the first identifier but not the second identifier to the management server 1. Likewise, the second terminal 5 may send a dissolution request that contains the second identifier but not the first identifier to the management server 1. In cases where a plurality of the correspondence relationships is allowed to be set, in other words in cases where the first or second target is associated with a plurality of other targets, the dissolution request may contain both the first identifier and the second identifier. In a mode, either the first terminal 4 or the second terminal 5 may send a dissolution request that contains the first identifier and the second identifier to the management server 1. In another mode, the first terminal 4 may send a dissolution request that contains one of the first identifier and the second identifier, and the second terminal 5 may send a dissolution request that contains the other. In still another mode, the management server 1 may assign an identifier to the set correspondence relationship and inform at least one of the first terminal 4 and the second terminal 5 of the assigned identifier at a certain time, such as when the notification indicating the result of the link processing is sent. At least one of the first terminal 4 and the second terminal 5 may specify the association to be dissolved by sending the dissolution request containing this identifier to the management server 1 to cause the management server to dissolve the specified association. According to this mode of the embodiment, the first identifier and the second identifier can be eliminated from the information contained in the dissolution request. Therefore, the efficiency of data communication with the dissolution request can be improved.

The dissolution request by at least one of the first terminal 4 and the second terminal 5 may be sent from the source terminal to the management server 1 either directly or indirectly via an external computer (e.g., first server 2 or the second server 3). The dissolution request by at least one of the first terminal 4 and the second terminal 5 may be sent to the management server 1 via the other of the first terminal 4 and the second terminal 5.

After receiving the dissolution request, the management server 1 consult the link information to dissolve the association that is specified by the identifier contained in the dissolution request. After executing this dissolution processing, the management server 1 may send a notification indicating the result of the dissolution processing to at least one of the first terminal 4 and the second terminal 5 as in the link processing.

The processing of dissolution request may include the processing of certifying the second target. The processing of certifying the second target may be the same as that in the link processing described above. However, the processing of certifying the second target is not necessarily required in the processing of dissolution request. In another mode, the processing of certification may be eliminated to simplify the processing of dissolution request.

The trigger of the dissolution request may be chosen appropriately depending on the mode of implementation. In a mode, in the case where at least one of the first target and the second target is a user, at least one of the first terminal 4 and the second terminal 5 may send the dissolution request in response to a user's operation performed on at least one of the first terminal 4 and the second terminal 5. In other words, the trigger of the dissolution request may be a user's operation. In another mode, upon expiration of the usage relationship, at least one of the first terminal 4 and the second terminal 5 may execute specific information processing. Triggered by this specific processing, at least one of the first terminal 4 and the second terminal 5 may send the dissolution request. For example, the specific information processing mentioned above may be data exchange between the first terminal 4 and the second terminal 5. The mode of data exchange with the processing of dissolution request may be the same as the mode of data exchange with the link setting. The data exchange with the link setting and the data exchange with the dissolution request may be distinguished from each other, when necessary. For example, as is the case with the entrance/exit of buses or ticket gates of railroad stations, the first terminal 4 may be equipped with different sensors for the entrance and the exit. In such cases, the data exchange with the link setting and the data exchange with the dissolution request may be distinguished from each other according to the sensor used in the data exchange. In another mode, in the case where the data exchange is performed by an application on the terminal, the application may be configured to be switchable between the link setting mode and the dissolution request mode. In this case, the data exchange with the link setting and the data exchange with the dissolution request may be distinguished from each other according to the mode of the application.

The first terminal 4 and the second terminal 5 may execute other internal processing. In a mode, in the case where at least one of the first terminal 4 and the second terminal 5 has current link information generated by it, the at least one terminal may update the current link information to past link information with the processing of dissolution request. The processing of updating the link information may be designed appropriately depending on the mode of implementation. For example, the processing of updating the link information may be the processing of deleting the current link information. In that case, the current link information may be either deleted completely or stored as a past link in the history. In a mode, the processing of updating the link information may be the processing of adding invalidating information such as an expiration time or an expiration flag to the current link information to invalidate the current link information. In the case where one of the first terminal 4 and the second terminal 5 is configured to send the dissolution request, this terminal may send a notification of dissolution of the link to the other terminal when it sends the dissolution request or when the dissolution of the link is completed. In the case where the other terminal has current link information generated by it, the other terminal may execute the processing of updating the current link information as described above upon receiving the above notification.

### (2) Condition for Dissolution

The condition for dissolution is a condition for dissolving the association between targets. The condition for dissolution may be defined appropriately depending on the mode of implementation.

In a mode, the condition for dissolution may be defined so as to dissolve the association at a dissolution time that is specified as desired. For example, the dissolution time may be specified by the user or another application (e.g., scheduler). In this case, the management server 1 may dissolve the association between the targets when the dissolution time arrives. The dissolution time may be set to the expiration time of the aforementioned link information. In the case where the dissolution time is set to the expiration time, the management server 1 may consider that the association between the targets is dissolved when the dissolution time arrives.

In another mode, the condition for dissolution may be defined so that the association is dissolved when the current locations of the respective targets fail to satisfy a predetermined condition of usage relationship. In other words, the condition for dissolution may be defined so that the association is dissolved when it is determined by the processing of checking the continuation of usage based on the current locations of the respective targets that the usage relationship does not continue.

As above, the management server 1 may dissolve the association when it receives a dissolution request from at least one of the first terminal 4 and the second terminal 5 or when a condition for dissolution is met. In this mode of the embodiment, it is possible to track the expiration of the usage relationship between the first target and the second target. After the dissolution of the association, the link information may be stored as a historical record.

### (Simplified Process of Link Establishment)

In a mode, in cases where the establishment and dissolution of a usage relationship between the same pair of first and second targets occurs repeatedly, the management system 100 may execute the certification of the second target every time it establishes and dissolves the usage relationship through repeated occurrences. However, if the frequency of the occurrences of the establishment and dissolution of the usage relationship is high, certifying the same second target every time can increase the load on the management system 100. Especially in cases where one of the first target and the second target is a user and the other is a mobility such as a user's own car for regular use, certifying the same second target every time can increase the load on the management system 100.

In view of the above, in another mode, the management system 100 may be configured to skip the processing of certifying the second target in the second and subsequent processes of setting the correspondence relationship between the same pair of first and second targets. In other words, the management system 100 may be configured to accept a request for the setting of a correspondence relationship without performing the processing of certifying the second target for the pairs of first and second targets for which the management system 100 has set a correspondence relationship in the past. For the sake of description, the process of setting a correspondence relationship without performing the processing of certifying the second target will be referred to as “the simplified process of link setting”, and the normal process that does not skip the certification will be referred to as “the normal process of link setting”.

The relationship between the organizations that operate the management server 1, the first server 2, and the second server 3 may be any relationship without limitations. In a mode, the operating organization of the management server 1 may be the same as the operating organization of at least one of the first server 2 and the second server 3. In another mode, the operating organization of the management server 1 may differ from the operating organizations of the first server 2 and the second server 3. The management system 100 according to the present disclosure may be produced by connecting the management server 1 to the first server 2, the second server 3, the first terminal 4, and the second terminal 5 through a network and arranging them in such a way that they can execute the information processing described above according to the intention of the operating organization of the management server 1.

### Operational Example

In a mode, one of the first target and the second target may be a user. One of the first terminal 4 and the second terminal 4 that is associated with the user may be a user's terminal associated with the user. The other of the first target and the second target may be a mobility that is used by the user. One of the first terminal 4 and the second terminal 5 that is associated with the mobility may be an on-board terminal provided in the mobility. According to a mode of the embodiment, it is possible to track the usage relationship between the user and the mobility with assured security.

The mobility may be any mobility that can used by the user, and its type is not specifically limited, but may be chosen appropriately depending on the mode of implementation. The type of the mobility may be chosen appropriately. For example, the mobility may be a vehicle, a train, an aircraft (e.g., an airplane, drone etc.), a ship, or other mobilities. The mobility may be at least one of a mobility manually controlled by a person and an autonomously-controlled unmanned mobility. In the case where the mobility is a vehicle, the type of the vehicle may be chosen as desired. For example, the vehicle type may be chosen from a two-wheeler, a three-wheeler, and a four-wheeler. The vehicle can include a personal car, a rental car, a taxi, and a bus. The vehicle may be at least one of an autonomous vehicle and a manually-driven vehicle. According to a mode of the embodiment, it is possible to track the usage relationship between the user and the mobility.

FIG. 2 is a diagram schematically illustrating an example situation where the management system 100 according to the present disclosure is applied. In the illustrative case in FIG. 2, the first target is a mobility and the second target is a user. In the following description of the case illustrated in FIG. 2, the terms modified by “first” shall refer to things related to the vehicle, and the terms modified by “second” shall refer to things related to the user.

In the case where the first target is a mobility, an example of the first terminal 4 is a mobility terminal (or on-board terminal). For example, the mobility terminal may be a terminal mounted on the interior or exterior of the mobility, a terminal carried by a person in charge of the operation of the mobility (e.g., the driver or conductor), or equipment of a facility related to the mobility (e.g., a ticket gate). In the case where the mobility is a vehicle, the mobility terminal can be called an on-board terminal.

An example of the first identifier is a mobility identifier (mobility ID or car ID). For example, the mobility identifier may be an ID of the mobility account, identification information assigned to the mobility such as the car registration number or the vehicle identification number (VIN), or identification information of the mobility terminal.

The mobility is an example of the thing used. The mode illustrated in FIG. 2 may be applied to any case in which the user (or occupant) of the thing used changes dynamically. Examples of the thing used other than a mobility can include a thing rented and an accommodation. The thing rented can include a rental office and a rental space.

In the case where the second target is a user, an example of the second terminal 5 is a user's terminal. For example, the user's terminal may be any computer such as a portable terminal (e.g., smartphone), a special-purpose device (e.g., electronic key device) or other computer devices. Typically, the user's terminal may be carried by the user to which it is linked (i.e., the second target). The account of the user may be shared among a plurality of computers, and each of the computers that share the account may be used as a user's terminal (the second terminal 5) of the same user.

An example of the second identifier is a user identifier (user ID or My ID). For example, the user identifier may be the ID of the user account, the personal number, or identification information of the user's terminal (e.g., the MAC address or terminal identification information).

In the case where the second target is a user, the information managed by the second server 3 includes information on the authority or authorities of the user in addition to information unique to the second target (e.g. the name of the user, biological information of the user, the personal number of the user) and the information used to certify the second target. The information on the authority of the user may be associated with various information E10 that is needed to exercise the authority. For example, the various information E10 may include information of public personal certification, payment information, and information related to other services. Examples of the information of public personal certification may include the personal number or the like. Examples of the payment information may include information on a credit card, information on Internet banking, and information on electronic payment. Examples of the information related to other services may include information related to an electronic prescription (e.g., an insurer number and/or prescription information). The various information E10 may be managed either by an external system or inside the management system 100. The second server 3 may be provided by a certificate authority or an affiliated organization of the certificate authority. The affiliated organization of the certificate authority may be a public organization, an independent organization, or a business entity (e.g., a vehicle manufacturer or a service provider). The second server 3 may be called a user-ID server or a My-ID server.

The management system 100 may be configured to set a link between the first identifier and the second identifier when the use of the mobility starts and to dissolve the link when the use of the mobility ends. When the link between the first identifier and the second identifier is set, the management system 100 may enable the exercise of the at least one of the authorities specified by the various information E10 associated with the user identified by the second identifier by the mobility identified by the first identifier (activated). When the link between the first identifier and the second identifier is dissolved, the management system 100 may also disable the authority activated as above (inactivated).

The start and the end of the use of the mobility may be detected by any method at certain timings, such as when the user gets on/off the mobility or when the user rents or returns the mobility. In a mode, the start and/or the end of the use of the mobility may be detected based on the execution of data exchange between the first terminal 4 and the second terminal 5.

The situation where the management system 100 according to the present disclosure is applied is not limited to a situation in which the relationship between the user and the mobility is to be tracked. In another mode, both the first target and the second target may be robot apparatuses that are configured to autonomously operate through autonomous control. The robot apparatus may include a mobility such as an autonomous vehicle or a drone. The management system 100 according to the present disclosure may be used to track the establishment and the termination of a relationship between robot apparatuses in a situation in which the two or more robot apparatuses autonomously interact.

In a concrete mode, one of the first target and the second target may be a large autonomous vehicle and the other may be a small autonomous vehicle. The large autonomous vehicle may be configured to be able to accommodate a plurality of small autonomous vehicles. The large autonomous vehicle may appropriately collect, convey, and release the small autonomous vehicles. The small autonomous vehicles may be operated appropriately at the site where they are released. In that case, the management system 100 according to the present disclosure may be configured to track whether the large autonomous vehicle is conveying (in other words, has collected) the small autonomous vehicles through the setting and the dissolution of correspondence relationship between the large autonomous vehicle and the small autonomous vehicles.

### (Data Exchange in Operation Example)

In the operational example according to the embodiment, a series of processing related to the setting of a link may be triggered by data exchange between the first terminal 4 and the second terminal 5 (the processing of steps SA101-SA102 in FIG. 2). The method of data exchange is not specifically limited, but may be chosen appropriately depending on the mode of implementation.

In a mode, the data exchange between the first terminal 4 and the second terminal 5 may be performed through wireless or cable data communication. For example, the wireless communication may be performed by NFC (Near Field Communication), Bluetooth (registered trademark), or Wi-Fi (registered trademark). For example, the cable communication may be performed through a wired LAN (Local Area Network) or a USB (Universal Serial Bus). The data communication may be performed either directly between the first terminal 4 and the second terminal 5 or indirectly through another computer. In another mode, the data exchange may be performed by a method different from data communication. For example, the data exchange may be performed by reading a two-dimensional code.

According to the embodiment, the data exchange between the first terminal 4 and the second terminal 5 is started by the provision of data (electronic information) from the first terminal 4 to the second terminal 5. In response to this, the second terminal 5 provides data to the first terminal 4, the provided data including an electronic certificate of the second target, the second identifier of the second target, and an electronic signature of the second target.

### (Electronic Certificate of Second Object in Operational Example)

In the operational example according to the embodiment, the electronic certificate of the second target is used to verify the authenticity of the second target. The electronic certificate is generated by a certificate authority. The certificate authority is a third-party organization that performs tasks related to certification such as issuing the electronic certificate of the second target. The certificate authority generates the electronic certificate of the second target in response to a request for the issuance of an electronic certificate from the user as the second target. In the case where the second server 3 is a server apparatus that is provided by the certificate authority, the user as the second target may submit a request for the issuance of an electronic certificate through the second server 3. In the case where the second server 3 is a server apparatus that is provided by an organization or entity that is different from the certificate authority, the user as the second target may submit a request for the issuance of an electronic certificate directly to the certificate authority.

Upon receiving the request for the issuance of an electronic certificate, the certificate authority identifies the second target based on information for publicly certifying the second target such as a driver's license, a driving record certificate, a passport, a personal number card (My number card), or various welfare handbooks with a picture of the second target affixed by public offices. If the identification succeeds, the certificate authority generates owner's identification information for the second target. The certificate authority calculates the hash value of a plaintext containing the owner's identification information generated in this way and a public key of the second target. The generation of the owner's identification information and the structure of the plaintext may be changed in any appropriate manner. The certificate authority encrypts the calculated hash value with a private key of the certificate authority to generate an electronic signature of the certificate authority. The certificate authority generates an electronic certificate containing information for reconstructing the plaintext (the owner's identification information of the second target, in the above mode), the public key of the second target, and the electronic signature of the certificate authority. The certificate authority registers the electronic certificate generated in this way in a repository. The private key and the public key of the second target may be generated either by the user as the second target or the certificate authority.

The electronic certificate generated by the certificate authority is sent to the user as the second target and stored in the second terminal 5. The electronic certificate or the owner's identification information contained in the electronic certificate may be sent from the second target to the second server 3 as information used to certify the second target and stored in the second server 3. The information used to certify the second target may include the public key of the certificate authority used in the generation of the electronic certificate of the second target in addition to the owner's identification information. The information used to certify the second target may be stored in the second server 3 in a manner linked with the second identifier when the account of the user as the second target is created.

### (Electronic Signature of Second Object in Operational Example)

In the operational example according to the embodiment, the electronic signature of the second target is generated using specific information that contains electronic information provided from the first terminal 4 to the second terminal 5 and the second identifier. In a mode, the electronic signature of the second target may be generated by encrypting the specific information with the private key of the second target that was generated when the electronic certificate of the second target was issued. The electronic information used to generate the electronic signature of the second target may be a random number generated by the first terminal 4, a time stamp or the like. The electronic information is not limited to a random number or a time stamp, but may be chosen appropriately according to the mode of implementation.

In the operational example according to the present disclosure, the private key and the public key of the user as the second target will be respectively referred to as “the private key A” and “the public key A”, and the private key and the public key of the certificate authority will be respectively referred to as “the private key B” and “the public key B”. The electronic signature of the second target will be referred to as “the electronic signature A”, and the electronic signature of the certificate authority will be referred to as “the electronic signature B”.

### (Certification of Second Object in Operational Example)

In the operational example according to the embodiment, the certification of the second target is fulfilled by verifying the authenticity of the second target. The process of verifying the authenticity of the second target according to the embodiment includes verifying the validity of the electronic certificate of the second target issued by the certificate authority, verifying the validity of the second identifier of the second target, and verifying the validity of the electronic signature A of the second target.

In the verification of the validity of the electronic certificate of the second target, firstly, the electronic signature B of the certificate authority contained in the electronic certificate of the second target is decrypted using the public key B of the certificate authority. Moreover, the hash value of the plaintext of the owner's identification information and the public key of the second target contained in the electronic certificate of the second target is calculated. Then, the decrypted information of the electronic signature B of the certificate authority is verified with the calculated hashed value. If the verification of the decrypted information of the electronic signature B of the certificate authority with the calculated hashed value succeeds, it is determined whether the electronic certificate of the second target is valid by consulting the repository of the certificate authority. If it is determined that the electronic certificate is valid, it is determined that the verification of the validity of the electronic certificate of the second target succeeds.

Next, the verification of the validity of the second identifier of the second target is performed using information stored in the second server 3 in a linked manner with the second identifier (the information used to certify the second target). In a mode, the information used to certify the second target may include the owner's identification information that was generated with the generation of the electronic certificate of the second target. In that case, the validity of the second identifier is verified by verifying the owner's identification information contained in the electronic certificate of the second target with the owner's identification information that has already been registered in the second server 3 in a linked manner with the second identifier. If the verification of the owner's identification information contained in the electronic certificate of the second target with the owner's identification information that has already been registered in the second server 3 in a linked manner with the second identifier succeeds, it is determined that the second identifier of the second target is valid.

The verification of the validity of the electronic certificate of the second target and the second identifier may be performed by the second server 3. In that case, the first terminal 4 may request the second server 3 to verify the validity of the electronic certificate of the second target and the second identifier by sending the second identifier and the electronic signature B provided by the second terminal 5 to the second server 3. Alternatively, the verification of the validity of the electronic certificate of the second target and the second identifier may be performed by the first terminal 4. In that case, the first terminal 4 may obtain the public key B of the certificate authority and the owner's identification information through the second server 3.

The verification of the electronic signature A of the second target is performed using the public key A of the second target contained in the electronic certificate of the second target. In the process of verifying the electronic signature A of the second target, firstly, the electronic signature A of the second target is decrypted using the public key A of the second target contained in the electronic certificate of the second target. Then, the decrypted information of the electronic signature A of the second target is verified with specific information. The specific information used in this verification is generated using electronic information provided from the first terminal 4 to the second terminal 5 and the second identifier provided from the second terminal 5 to the first terminal 4. If the verification of the decrypted information of the electronic signature A of the second target with the specific information succeeds, it is determined that the electronic signature A of the second target is valid.

The verification of the validity of the electronic signature A of the second target may be performed by the first terminal 4. In that case, the first terminal 4 may decrypt the electronic signature A of the second target using the public key A contained in the electronic certificate provided from the second terminal 5 and generate the specific information using the electronic information provided to the second terminal 5 and the second identifier provided from the second terminal 5. Alternatively, the verification of the validity of the electronic signature A of the second target may be performed by the second server 3. In that case, the first terminal 4 may request the second server 3 to verify the validity of the electronic signature A of the second target by sending the electronic certificate of the second target, the electronic signature A of the second target, and the specific information to the second server 3.

If the certification of the second target described above succeeds, it is certified that the electronic signature A was generated using the private key A of the second target and the electronic information provided by the first terminal 4. This means that the provider of the electronic signature A has the private key A of the second target, and the receiver of the electronic information is consistent with the provider of the electronic signature A. In other words, it is assured that the provider of the electronic signature A is consistent with the second target identified by the certificate authority. It is also assured that the provider of the electronic certificate and the second identifier is consistent with the second target already registered in the second server 3. Therefore, if the certification of the second target succeeds, the authenticity of the second target is assured.

### (Use of Link Information in Operational Example)

As described above, the link information may be used in various situations. For example, the link information may be used to simply track the establishment and the dissolution of a correspondence relationship between the first target and the second target. In another mode, the link information may be used to allow an authority linked with either one of the first target and the second target to be exercised by the other while an established correspondence relationship between the first target and the second target is present. In the case illustrated in FIG. 2, the link information may be used to allow at least one or more of the authorities linked with the user to be exercises through the mobility while the association between the user and the mobility exists.

For example, in the case where the authorities that the user has include an authority related to a public service, the exercise of at least one or more of the authorities linked with the user through the mobility may be using the public service that the user has the authority to enjoy using the first identifier of the mobility. In the case where the authorities that the user has include an authority to use a payment service, the exercise of at least one or more of the authorities linked with the user through the mobility may be enjoying the payment service that the user has the authority to enjoy using the first identifier of the mobility. For example, the payment service may be used to pay a fee for a parking lot, a highway toll, a fee for a drive-through service, or a fare on the public transportation. In the case where the authorities that the user has include an authority related to an electronic prescription service, the exercise of at least one or more of the authorities linked with the user through the mobility may be enjoying the electronic prescription service that the user has the authority to enjoy using the first identifier of the mobility. For example, using the electronic prescription service may be receiving medicine prescribed by an electronic prescription.

(Data Communication between Apparatuses in Operational Example)

The mode of data communication between the apparatuses including the management server 1, the first server 2, the second server 3, the first terminal 4, and the second terminal 5 is not specifically limited, but may be chosen appropriately depending on the mode of implementation. The networks between the apparatuses may be chosen appropriately from among the Internet, a wireless communication network, a mobile communication network, a telephone network, a special purpose network, and a local area network etc. The data communication between the apparatuses may be encrypted by SSL (Secure Socket Layer), TLS (transport Layer Security) or other method. In a mode, the first terminal 4 and the second terminal 5 may be provided with a SIM (Subscriber Identity Module), and data communication between the first terminal 4 and the second terminal 5 with the management server 1 may be performed as encrypted communication using the SIM.

### <<Hardware Configuration>>

### (Management Server)

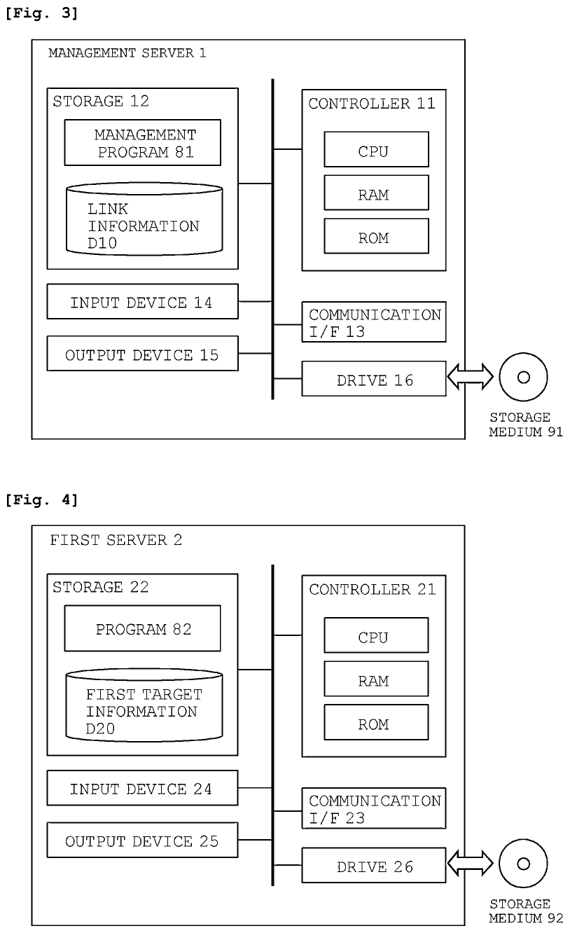

FIG. 3 is a diagram illustrating an example of the hardware configuration of the management server 1 used in the operational example according to the embodiment. The management server 1 according to the embodiment is a computer that have a controller 11, a storage 12, a communication interface 13, an input device 14, an output device 15, and a drive 16, which are electrically interconnected.

The controller 11 includes a hardware processor such as a CPU (Central Processing Unit), RAM (Random Access Memory), and ROM (Read Only Memory). The controller 11 is configured to execute various information processing based on programs and various data. The controller 11 (CPU) is an example of the processor resources of the management server 1.

Examples of the storage 12 may include a hard disk drive, a solid-state drive, and a semiconductor memory. The storage 12 (and the RAM and ROM) is an example of the memory resources. In the embodiment, the storage 12 stores various information including a management program 81 and link information D10. The management program 81 is configured to cause the management server 1 to execute the information processing related to the establishment and the dissolution of a correspondence relationship between the first target and the second target. The management program 81 includes a series of commands of this information processing.

The communication interface 13 is configured to perform cable or wireless communication through a network. For example, the communication interface 13 may include a wired LAN (Local Area Network) module or a wireless LAN module. The management server 1 can perform data communication with other computers such as the first server 2, the second server 3, the first terminal 4, and the second terminal 5 through the communication interface 13.

The input device 14 is a device used to perform input operations, examples of which include a mouse, a key board, and operation buttons. The output device 15 is a device used to output information, examples of which include a display and a speaker. The operator can operate the management server 1 using the input device 14 and the output device 15. The input device 14 and the output device 15 may be constituted by an integral unit such as a touch panel display. The input device 14 and the output device 15 may be connected through an external interface. For example, the external interface may be configured to be connected to external devices by cables or wirelessly through a USB (Universal Serial Bus) port, a special-purpose port, and/or wireless communication port.

The drive 16 is a device used to read various information such as programs stored in a storage medium 91. At least one of the aforementioned management program 81 and the link information 10 may be stored in the storage medium 91 instead of or as well as the storage 12. The storage medium 91 is adapted to store various information by electrical, magnetic, optical, or chemical effects in such a way that machines such as a computer can read the stored information (stored programs etc.). The management server 1 may retrieve at least one of the management program 81 and the link information D10 from the storage medium 91. The storage medium 91 may be either a disc storage medium such as a CD or a DVD or a non-disc storage medium such as a semiconductor memory (e.g., a flash memory). The type of the drive 16 may be chosen appropriately in accordance with the type of the storage medium 91. The drive 16 may be connected through an external interface.

One or more hardware components of the management server 1 can be eliminated, replaced by other components, and/or augmented by other components in an appropriate manner depending on the mode of implementation. For example, the controller 11 may include a plurality of hardware processors. The hardware processors may include a microprocessor(s), an FPGA(s) (Field-Programmable Gate Array), a DSP(s) (Digital Signal Processor), and/or a GPU(s) (Graphics Processing Unit). At least one of the input device 14, the output device 15, and the drive 16 may be eliminated. The link information D10 may be stored in an external computer (e.g., an NAS: Network Attached Storage) that is accessible by the management server 1 instead of the storage 12. The management server 1 may be constituted by a plurality of computers. In that case, the hardware configurations of the computers may be either identical or different. The management server 1 may be an information processing apparatus that is specially designed to provide intended services, a general-purpose server apparatus, or a general-purpose computer.

### (First Server)

FIG. 4 schematically illustrates an example of the hardware configuration of the first server 2 used in the operational example according to the embodiment. The first server 2 according to the embodiment is a computer that has a controller 21, a storage 22, a communication interface 23, an input device 24, an output device 25, and a drive 26, which are electrically interconnected. The controller 21, the storage 22, the communication interface 23, the input device 24, the output device 25, the drive 26, and a storage medium 92 of the first server 2 may respectively be configured in the same manner as the controller 11, the storage 12, the communication interface 13, the input device 14, the output device 15, the drive 16, and the storage medium 91 of the management server 1 described above.

The controller 21 (CPU) is an example of the processor resources of the first server 2, and the storage 22 (and the RAM and ROM) is an example of the memory resources of the first server 2. The storage 22 according to the embodiment stores various information including a program 82 and first target information D20. The program 82 is configured to cause the first server 2 to execute information processing related to the first target. The program 82 includes a series of commands of this information processing. At least one of the program 82 and the first target information D20 may be stored in the storage medium 92 instead of or as well as the storage 22. The first server 2 may retrieve at least one of the program 82 and the first target information D20 from the storage medium 92. The first server 2 may perform data communication with other computers (such as the management server 1) through the communication interface 23. The first server 2 may be operated using the input device 24 and the output device 25.

One or more hardware components of the first server 2 can be eliminated, replaced by other components, and/or augmented by other components in an appropriate manner depending on the mode of implementation. For example, the controller 21 may include a plurality of hardware processors. The hardware processors may include a microprocessor(s), an FPGA(s), a DSP(s), and/or a GPU(s). At least one of the input device 24, the output device 25, and the drive 26 may be eliminated. The first target information D20 may be stored in an external computer (e.g., an NAS) that is accessible by the first server 2 instead of the storage 22. The first server 2 may be constituted by a plurality of computers. In that case, the hardware configurations of the computers may be either identical or different. The first server 2 may be an information processing apparatus that is specially designed to provide intended services, a general-purpose server apparatus, or a general-purpose computer.

### (Second Server)

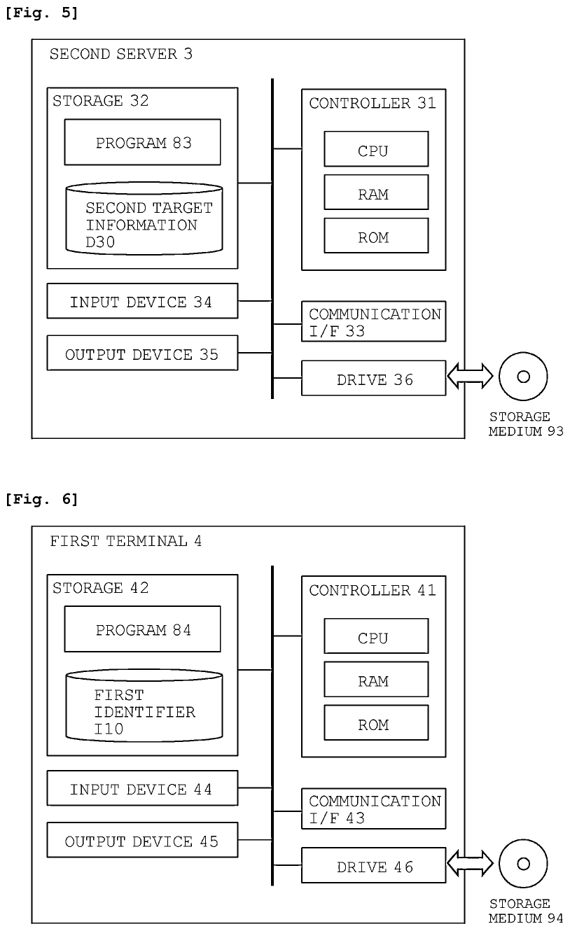

FIG. 5 schematically illustrates an example of the hardware configuration of the second server 3 used in the operational example according to the embodiment. The second server 3 according to the embodiment is a computer that has a controller 31, a storage 32, a communication interface 33, an input device 34, an output device 35, and a drive 36, which are electrically interconnected. The controller 31, the storage 32, the communication interface 33, the input device 34, the output device 35, the drive 36, and a storage medium 93 of the second server 3 may respectively be configured in the same manner as the controller 11, the storage 12, the communication interface 13, the input device 14, the output device 15, the drive 16, and the storage medium 91 of the management server 1 described above.

The controller 31 (CPU) is an example of the processor resources of the second server 3, and the storage 32 (as well as the RAM and ROM) is an example of the memory resources of the second server 3. The storage 32 according to the embodiment stores various information including a program 83 and second target information D30. The program 83 is configured to cause the second server 3 to execute information processing related to the second target. The program 83 includes a series of commands of this information processing. At least one of the program 83 and the second target information D30 may be stored in the storage medium 93 instead of or as well as the storage 32. The second server 3 may retrieve at least one of the program 83 and the second target information D30 from the storage medium 93. The second server 3 may perform data communication with other computers (such as the management server 1) through the communication interface 33. The second server 3 may be operated using the input device 34 and the output device 35.

One or more hardware components of the second server 3 can be eliminated, replaced by other components, and/or augmented by other components in an appropriate manner depending on the mode of implementation. For example, the controller 31 may include a plurality of hardware processors. The hardware processors may include a microprocessor(s), an FPGA(s), a DSP(s), and/or a GPU(s). At least one of the input device 34, the output device 35, and the drive 36 may be eliminated. The second target information D30 may be stored in an external computer (e.g., an NAS) that is accessible by the second server 3 instead of the storage 32. The second server 3 may be constituted by a plurality of computers. In that case, the hardware configurations of the computers may be either identical or different. The second server 3 may be an information processing apparatus that is specially designed to provide intended services, a general-purpose server apparatus, or a general-purpose computer.

### (First Terminal)

FIG. 6 schematically illustrates an example of the hardware configuration of the first terminal 4 used in the operational example according to the embodiment. The first terminal 4 according to the embodiment is a computer that has a controller 41, a storage 42, a communication interface 43, an input device 44, an output device 45, and a drive 46, which are electrically interconnected. The controller 41, the storage 42, the communication interface 43, the input device 44, the output device 45, the drive 46, and a storage medium 94 of the first terminal 4 may respectively be configured in the same manner as the controller 11, the storage 12, the communication interface 13, the input device 14, the output device 15, the drive 16, and the storage medium 91 of the management server 1 described above.

The controller 41 (CPU) is an example of the processor resources of the first terminal 4, and the storage 42 (as well as the RAM and ROM) is an example of the memory resources of the first terminal 4. The storage 42 according to the embodiment stores various information including a program 84 and the first identifier I10. The program 84 is configured to cause the first terminal 4 to execute information processing related to linking. The program 84 includes a series of commands of this information processing. At least one of the program 84 and the first identifier I10 may be stored in the storage medium 94 instead of or as well as the storage 42. The first terminal 4 may retrieve at least one of the program 84 and the first identifier I10 from the storage medium 94. The first terminal 4 may perform data communication with other computers (such as the management server 1 and the second terminal 5) through the communication interface 43. The first terminal 4 may be operated using the input device 44 and the output device 45.

One or more hardware components of the first terminal 4 can be eliminated, replaced by other components, and/or augmented by other components in an appropriate manner depending on the mode of implementation. For example, the controller 41 may include a plurality of hardware processors. The hardware processors may include a microprocessor(s), an FPGA(s), a DSP(s), a GPU(s), and/or an ECU(s) (Electronic Control Unit). At least one of the input device 44, the output device 45, and the drive 46 may be eliminated. The first identifier I10 may not be stored in the storage 42. The first identifier I10 may be acquired every time when needed. To acquire data such as identifiers and/or unique information, the first terminal 4 may be further provided with a data acquisition device such as a sensor or a reader. The communication interface 43 may be composed of a plurality of modules. For example, the communication interface 43 may include a near field communication module and a wireless communication module; the first terminal 4 may perform data communication with the second terminal 5 through the near field communication module and with the management server 1 through the wireless communication module. The first terminal 4 may be constituted by a plurality of computers. In that case, the hardware configurations of the computers may be either identical or different. The first terminal 4 may be an information processing apparatus that is specially designed to provide intended services, a general-purpose computer, or a terminal device designed to be provided on a mobility.

### (Second Terminal)

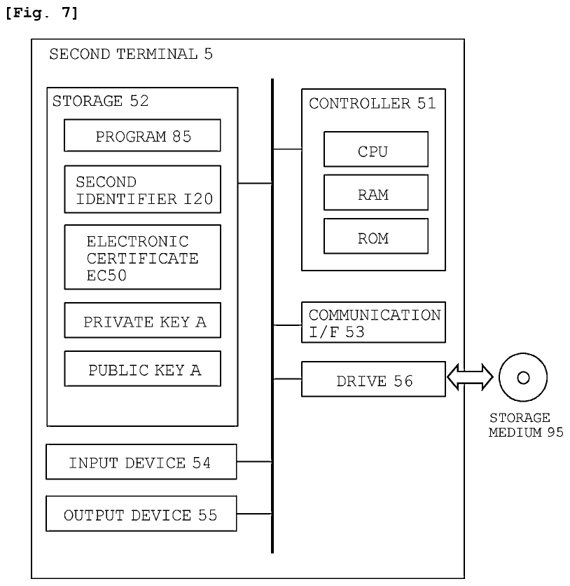

FIG. 7 schematically illustrates an example of the hardware configuration of the second terminal 5 used in the operational example according to the embodiment. The second terminal 5 according to the embodiment is a computer that has a controller 51, a storage 52, a communication interface 53, an input device 54, an output device 55, and a drive 56, which are electrically interconnected. The controller 51, the storage 52, the communication interface 53, the input device 54, the output device 55, the drive 56, and a storage medium 95 of the second terminal 5 may respectively be configured in the same manner as the controller 11, the storage 12, the communication interface 13, the input device 14, the output device 15, the drive 16, and the storage medium 91 of the management server 1 described above.

The controller 51 (CPU) is an example of the processor resources of the second terminal 5, and the storage 52 (as well as the RAM and ROM) is an example of the memory resources of the second terminal 5. The storage 52 according to the embodiment stores various information including a program 85, the second identifier 120, an electronic certificate EC50, a private key A, and a public key A. The program 85 is configured to cause the second terminal 5 to execute information processing related to linking. The program 85 includes a series of commands of this information processing. At least one of the program 85, the second identifier 120, the electronic certificate EC50, the private key A, and the public key A may be stored in the storage medium 95 instead of or as well as the storage 52. The second terminal 5 may retrieve at least one of the program 85, the second identifier 120, the electronic certificate EC50, the private key A, and the public key A from the storage medium 95. The second terminal 5 may perform data communication with other computers (such as the management server 1 and the first terminal 4) through the communication interface 53. The second terminal 5 may be operated using the input device 54 and the output device 55.

One or more hardware components of the second terminal 5 can be eliminated, replaced by other components, and/or augmented by other components in an appropriate manner depending on the mode of implementation. For example, the controller 51 may include a plurality of hardware processors. The hardware processors may include a microprocessor(s), an FPGA(s), a DSP(s), a GPU(s), and/or an ECU(s). At least one of the input device 54, the output device 55, and the drive 56 may be eliminated. The second identifier 120, the electronic certificate EC50, the private key A, and the public key A may not be stored in the storage 52. The second identifier 120, the electronic certificate EC50, the private key A, and the public key A may be acquired every time when needed. In that case, the second terminal 5 may be further provided with a data acquisition device such as a sensor and/or a reader to acquire the various data every time when needed. As in the first terminal 4, the communication interface 53 may be composed of a plurality of modules. The second terminal 5 may be constituted by a plurality of computers. In that case, the hardware configurations of the computers may be either identical or different. The second terminal 5 may be an information processing apparatus that is specially designed to provide intended services, a general-purpose computer, or a terminal device designed to be used by a user (e.g., a smartphone or tablet PC).

### <<Example of Software Configuration>>

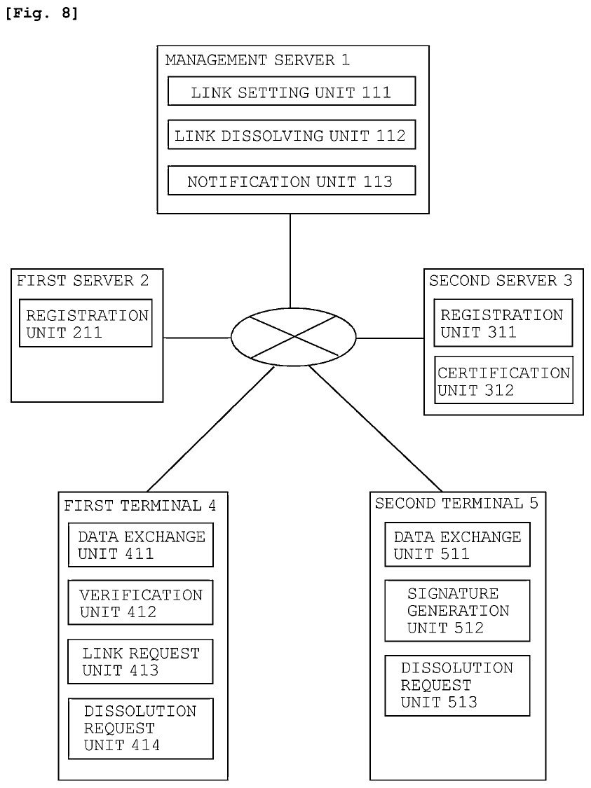

FIG. 8 is a diagram illustrating an example of the software configurations of the apparatuses according to the embodiment, which include the management server 1, the first server 2, the second server 3, the first terminal 4, and the second terminal 5.

### (Management Server)

The controller 11 of the management server 1 develops the management program 81 stored in the storage 12 into the RAM and executes the commands of the program 81 through the CPU, whereby the management server 1 operates as a computer that has a link setting unit 111, a link dissolving unit 112, and a notification unit 113 as software modules.

The link setting unit 111 is configured to execute the processing of setting a correspondence relationship between the first identifier I10 and the second identifier 120 when receiving a link request (a request to set a correspondence relationship between the first identifier I10 and the second identifier 120) from the first terminal 4. In the processing of setting a correspondence relationship between the first identifier I10 and the second identifier 120, the link setting unit 111 generates link information D10 for linking the first identifier I10 and the second identifier 120 and stores the generated link information D10 in the storage 12.

When the link setting unit 111 receives the link request from the first terminal 4, the link setting unit 111 may execute the certification of the first target through the first server 2. Then, the link setting unit 111 may set a correspondence relationship between the first identifier I10 and the second identifier 120 on condition that the certification of the first target succeeds. In a mode, the certification of the first target may be performed using unique information of the first target. In that case, the link request sent from the first terminal 4 to the management server 1 may contain the unique information of the first target. Then, the link setting unit 111 may request the first server 2 to perform the certification of the first target by sending the first identifier I10 and the unique information of the first target to the first server 2.

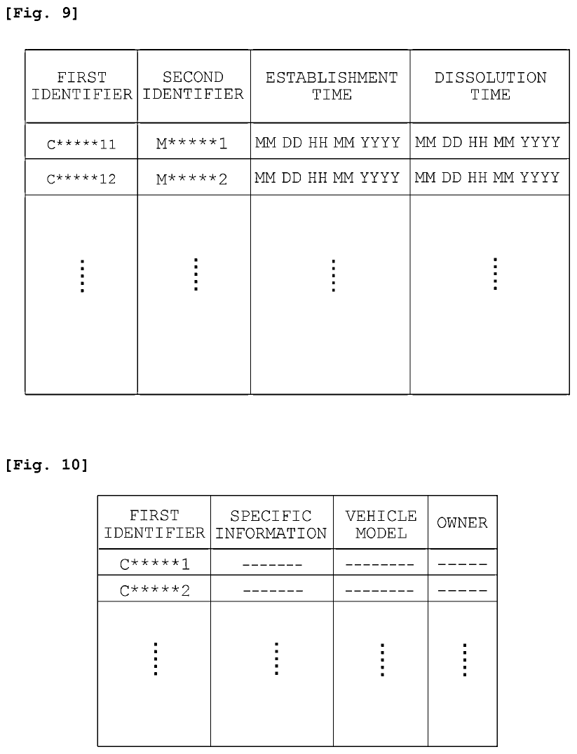

In a mode, as illustrated in FIG. 9, the link information D10 stored in the storage 12 may contain the first identifier I10, the second identifier 120, the establishment time, and the dissolution time. The establishment time refers to the time when a correspondence relationship between the first target and the second target was established. The establishment time may be a time stamp. The dissolution time refers to the time when the association between the first target and the second target is dissolved. The value of the dissolution time may be added when the processing of dissolving the association is executed. The way of indicating the dissolution is not limited to this. In another mode, the dissolution time may be replaced by at least one of the expiration time and a flag. The expiration time refers to the time until when the established correspondence relationship is valid. Then, whether the set correspondence relationship is valid or not (in other words, whether the association is still present or has been dissolved) is indicated by whether the current time is before the expiration time or not. The flag indicates whether the association has been dissolved or not. The flag may be set when the processing of dissolving the association is executed. In still another mode, the link information D10 may contain at least one of the expiration time and the flag in addition to the dissolution time field. The structure of the link information D10 is not limited to the structure illustrated in FIG. 9, but may be changed appropriately depending on the mode of implementation, on condition that it is able to indicate the state of the set correspondence relationship. In another mode, the link information D10 may contain information indicating the type of the used target (whether it is a target that is used on a full-time basis or a use target that is used on a temporary basis). The types of the used target are not necessarily required to be distinguished by separate information. For example, the types of the used target may be distinguished by other information such as the identifiers.

The link dissolving unit 112 is configured to dissolve the association when a dissolution request from at least one of the first terminal 4 and the second terminal 5 is received or when a predetermined condition for dissolution is met. The notification unit 113 is configured to send a notification that indicates the result of the processing of setting the correspondence relationship to at least one of the first terminal 4 and the second terminal 5. The notification unit 113 is also configured to send a notification that indicates the result of the processing of dissolving the association to at least one of the first terminal 4 and the second terminal 5.

### (First Server)

The controller 21 of the first server 2 executes the commands of the program 82 through the CPU, whereby the first server 2 operates as a computer that has a registration unit 211 as a software module. The registration unit 211 executes the processing of creating an account of the first target in response to a request to create an account of the first target. In the processing of creating an account of the first target, the registration unit 211 generates a first identifier I10 of the first target and stores first target information D20 containing the generated first identifier I10 in the storage 22. In a mode, as illustrated in FIG. 10, the first target information D20 stored in the storage 22 may contain the first identifier I10, unique information (e.g. car registration number, car identification information, or identification information of the first terminal 4), the vehicle model, and the owner.

The first server 2 may further have a software module configured to perform the certification of the first target in response to a certification request from the management server 1. In a mode, the software module may access the first target information D20 stored in the storage 22 using the first identifier I10 contained in the certification request from the management server 1 as an argument to retrieve the already-registered unique information that is linked with the first identifier I10. Then, the software module may perform the certification of the first target by verifying the unique information contained in the certification request from the management server 1 with the unique information retrieved as above.

### (Second Server)

The controller 31 of the second server 3 executes the commands of the program 83 through the CPU, whereby the second server 3 operates as a computer that has a registration unit 311 and a certification unit 312 as software modules.

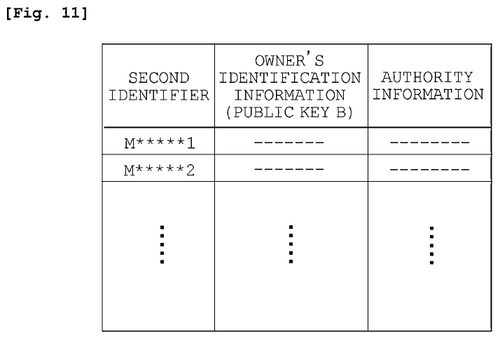

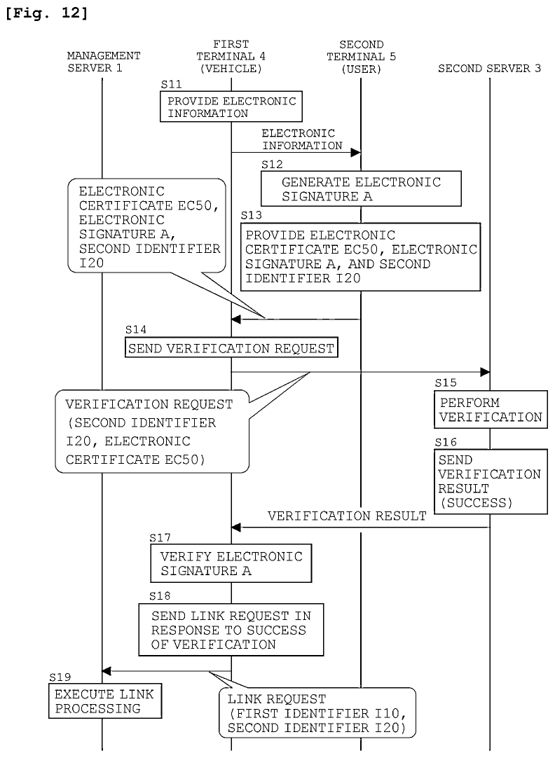

The registration unit 311 executes the processing of creating an account of the second target in response to a request to create an account of the second target. In the processing of creating an account of the second target, the registration unit 311 generates a second identifier 120 of the second target and stores second target information D30 containing the generated second identifier 120 in the storage 32. In a mode, as illustrated in FIG. 11, the second target information D30 stored in the storage 32 may contain the second identifier 120, owner's identification information, and authority information. The owner's identification information is an example of information used to certify the second target. Besides the owner's identification information, the information used to certify the second target may include the public key B of the certificate authority that was used to generate the electronic certificate of the second target. The authority information is information related to the authority or authorities of the associated user. For example, the authority information may include information that is used to cooperate with a server that executes information processing related to an authority or authorities of the user and information indicating association with the various information E10.

The certification unit 312 performs the verification of the validity of the electronic certificate EC50 of the second target and the validity of the second identifier 120 of the second target in response to a verification request (a request for the verification of the validity of the second identifier 120 and the electronic certificate EC50) from the first terminal 4. In the process of verifying the validity of the electronic certificate of the second target, the certification unit 312 firstly decrypts the electronic signature B of the certificate authority contained in the electronic certificate of the second target using the public key B of the certificate authority. Furthermore, the certification unit 312 calculates the hash value of the plaintext of the public key of the second target and the owner's identification information contained in the electronic certificate of the second target. Then, the certification unit 312 verifies the decrypted information of the electronic signature B of the certificate authority with the calculated hash value. If the verification of the decrypted information of the electronic signature B of the certificate authority with the calculated hash value succeeds, the certification unit 312 consults the repository of the certificate authority to determine whether the electronic certificate EC50 of the second target is valid. If it is determined that the electronic certificate is valid, the certification unit 312 determines that the verification of the validity of the electronic certificate of the second target succeeds.

In the process of verifying the validity of the second identifier 120, the certification unit 312 verifies the validity of the second identifier by verifying the owner's identification information contained in the electronic certificate EC50 of the second target with the owner's identification information contained in the second target information D30 stored in the storage 32. If the verification of the owner's identification information contained in the electronic certificate EC50 of the second target with the owner's identification information contained in the second target information D30 stored in the storage 32 succeeds, the certification unit 312 determines that the second identifier of the second target is valid.

The certification unit 312 sends the result of the verification of the validity of the electronic certificate EC50 and the second identifier 120 to the first terminal 4 through the communication interface 33.

### (First Terminal)

The controller 41 of the first terminal 4 executes the commands of the program 84 through the CPU, whereby the first terminal 4 operates as a computer that has a data exchange unit 411, a verification unit 412, a link request unit 413, and a dissolution request unit 414 as software modules. The data exchange unit 411 is configured to perform data exchange with the second terminal 5. According to the embodiment, the data exchange unit 411 is configured to perform the processing of generating electronic information and providing the generated electronic information to the second terminal 5, which is triggered by the establishment of a usage relationship between the first target and the second target. The data exchange unit 411 is configured also to receive the electronic certificate EC50, the second identifier 120, and the electronic signature A of the second target provided by the second terminal 5 and to pass the received data to the verification unit 412, which will be described in further detail later.

The verification unit 412 is configured to perform the verification of the authenticity of the second target. In the process of verifying the authenticity of the second target, the verification unit 412 performs the verification of the validity of the electronic certificate EC50 of the second target, the verification of the validity of the second identifier 120 of the second target, and the verification of the validity of the electronic signature A of the second target. According to the embodiment, the verification unit 412 delegates the verification of the validity of the electronic certificate EC50 of the second target and the verification of the validity of the second identifier 120 of the second target to the second server 3. The verification unit 412 performs the verification of the validity of the electronic signature A of the second target by itself. In the process of verifying the validity of the electronic signature A of the second target, the verification unit 412 firstly decrypts the electronic signature A of the second target using the public key A of the second target contained in the electronic certificate EC50 of the second target. Furthermore, the verification unit 412 generates specific information using the electronic information provided from the first terminal 4 to the second terminal 5 and the second identifier 120 provided from the second terminal 5 to the first terminal 4. Then, the verification unit 412 verifies the decrypted information of the electronic signature A of the second target with the specific information generated as above. If the verification of the decrypted information of the electronic signature A of the second target with the specific information succeeds, the verification unit 412 determines that the electronic signature A of the second target is valid.

The link request unit 413 is configured to request the management server 1 to set a correspondence relationship (Linking) between the first target and the second target on condition that the verification of the validity of the electronic certificate EC50, the verification of the validity of the second identifier 120, and the verification of the validity of the electronic signature A succeed. The dissolution request unit 414 is configured to request the management server 1 to dissolve the association between the first target and the second target.

### (Second Terminal)

The controller 51 of the second terminal 5 executes the commands of the program 85 through the CPU, whereby the second terminal 5 operates as a computer that has a data exchange unit 511, a signature generation unit 512, and a dissolution request unit 513 as software modules. The data exchange unit 511 is configured to perform data exchange with the first terminal 4. According to the embodiment, the data exchange unit 511 is configured to receive the electronic information provided from the first terminal 4 and to pass the received data to the signature generation unit 512, which will be described in further detail later. The data exchange unit 511 is configured also to provide the electronic certificate EC50, the second identifier 120, and the electronic signature A generated by the signature generation unit 512 to the first terminal 4.

The signature generation unit 512 is configured to generate the electronic signature A of the second target, which is triggered by the receipt of the electronic information provided from the first terminal 4 by the data exchange unit 511. In the process of generating the electronic signature A of the second target, the signature generation unit 512 firstly generates specific information that contains the electronic information provided from the first terminal 4 and the second identifier 120. Then, the signature generation unit 512 encrypts the specific information generated as above using the private key A of the second target to generate the electronic signature A of the second target.

The dissolution request unit 513 is configured to request the management server 1 to dissolve the association.

According to the present description of the embodiment, all the software modules of each apparatus are implemented by a general-purpose CPU. However, one or more or all of the software modules may be implemented by one or more special-purpose processors. The above modules may be implemented as hardware modules. One or more software modules of each apparatus may be eliminated, replaced by other modules, and/or augmented by other modules in an appropriate manner depending on the mode of implementation.

### <<Example of Operation>>

FIG. 12 is a diagram illustrating an example of the procedure of setting a link by the management system 100 in the operational example according to the embodiment. The following procedure is an example of the management method performed by a computer.

In step S11, the controller 41 of the first terminal 4 operates as the data exchange unit 411 to provide electronic information to the second terminal 5. In response to this, the controller 51 of the second terminal 5 operates as the data exchange unit 511 to receive the electronic information provided by the first terminal 4.

In step S12, the controller 51 of the second terminal 5 operates as the signature generation unit 512 to generate the electronic signature A of the second target using the electronic information provided from the first terminal 4. In a mode, the signature generation unit 512 firstly generates specific information that contains the electronic information provided from the first terminal 4 and the second identifier 120 stored in the storage 52. Then, the signature generation unit 512 encrypts the specific information generated as above using the private key A of the second target stored in the storage 52 to generate the electronic signature A of the second target.

In step S13, the controller 51 of the second terminal 5 operates as the data exchange unit 511 to provide the electronic signature A of the second target generated as above, the second identifier 120 stored in the storage 52, and the electronic certificate EC50 stored in the storage 52 to the first terminal 4. In response to this, the controller 41 of the first terminal 4 operates as the data exchange unit 411 to receive the electronic signature A, the second identifier 120, and the electronic certificate EC50 provided from the second terminal 5.

In step S14, the controller 41 of the first terminal 4 operates as the verification unit 412 to send the second identifier 120 and the electronic certificate EC50 provided from the second terminal 5 to the second server 3 to request the second server 3 to verify the validity of the second identifier 120 and the electronic certificate EC50. The first terminal 4 sends the second identifier 120 and the electronic certificate EC50 to the management server 1 through the communication interface 43.

In step S15, the second server 3 receives the verification request sent from the first terminal 4 through the communication interface 33. When the second server 3 receives the verification request from the first terminal 4, the controller 31 of the second server 3 operates as the certification unit 312 to execute the processing of verifying the validity of the second identifier 120 and the electronic certificate EC50 received from the first terminal 4. In a mode, the certification unit 312 accesses the second target information D30 stored in the storage 32 using the second identifier 120 as an argument to retrieve the public key B of the certificate authority. The certification unit 312 decrypts the electronic signature A of the certificate authority contained in the electronic certificate EC50 using the retrieved public key B. Furthermore, the certification unit 312 calculates the hash value of the plaintext of the owner's identification information and the public key A of the second target contained in the electronic certificate EC50. Then, the certification unit 312 verifies the decrypted information of the electronic signature B of the certificate authority with the calculated hash value. If the verification of the decrypted information of the electronic signature B of the certificate authority with the calculated hash value succeeds, the certification unit 312 consults the repository of the certificate authority to determine whether the electronic certificate EC50 of the second target is valid. If it is determined that the electronic certificate is valid, the certification unit 312 determines that the verification of the validity of the electronic certificate of the second target succeeds.

In a mode, in the process of verifying the validity of the second identifier 120, the certification unit 312 accesses the second target information D30 stored in the storage 32 using the second identifier 120 as an argument to retrieve the owner's identification information associated with the second target. Then, the certification unit 312 verifies the owner's identification information contained in the electronic certificate EC50 with the retrieved owner's identification information to verify the validity of the second identifier. If the verification of the owner's identification information contained in the electronic certificate EC50 with the retrieved owner's identification information succeeds, the certification unit 312 determines that the second identifier 120 of the second target is valid.

If the verification of the validity of the second identifier 120 and the electronic certificate EC50 succeeds, the certification unit 312 sends the result of the verification (i.e., the success of the verification) to the first terminal 4 through the communication interface 33 (step S16).

In step S17, the first terminal 4 receives the result of the verification sent from the second server 3 through the communication interface 43. Upon receiving the result of the verification from the second server 3, the first terminal 4 operates as the verification unit 412 to verify the validity of the electronic signature A of the second target provided from the second terminal 5. In a mode, the verification unit 412 firstly decrypts the electronic signature A of the second target using the public key A of the second target contained in the electronic certificate EC50 of the second target. Furthermore, the verification unit 412 generates specific information using the electronic information provided from the first terminal 4 to the second terminal 5 and the second identifier 120 provided from the second terminal 5 to the first terminal 4. Then, the verification unit 412 verifies the decrypted information of the electronic signature A of the second target with the specific information generated as above. If the verification of the decrypted information of the electronic signature A of the second target with the specific information succeeds, the verification unit 412 determines that the electronic signature A of the second target is valid.

In step S18, in response to the success of the verification of the validity of the electronic certificate EC50, the second identifier 120, and the electronic signature A, the controller 41 of the first terminal 4 operates as the link request unit 413 to request the management server 1 to set a correspondence relationship between the first target and the second target. Specifically, the link request unit 413 sends a link request containing the first identifier I10 and the second identifier 120 to the management server 1 through the communication interface 43.

In step S19, the management server 1 receives the link request sent from the first terminal 4 through the communication interface 13. Then, the controller 11 of the management server 1 operates as the link setting unit 111 to execute the link processing. In a mode, in the link processing, the link setting unit 111 generates link information D10 for linking the first identifier I10 and the second identifier 120 and stores the generated link information D10 in the storage 12.

According to the embodiment, in response to the establishment of a usage relationship between the first target and the second target, the verification of the authenticity of the second target is performed (steps S14-S17 in FIG. 12). This ensures the security. If the verification of the authenticity of the second target succeeds, a correspondence relationship between the first identifier I10 and the second identifier 120 is set. The record of the set link makes it possible to track the usage relationship between the first target and the second target. Therefore, according to the embodiment, it is possible to track the usage relationship between the first target and the second target with assured security.

### First Modification

While an operational example according to the embodiment of the disclosed technology has been described, what has been described in the foregoing is merely an example of the present disclosure. It is obvious that various improvements and modifications can be made thereto without departing from the scope of the disclosure. For example, the following modification can be made. In the following description, components similar to those in the operational example described above are denoted by the same reference signs and will not be described in further detail.

In a mode, the management system 100 may be configured to allow a proxy user for the second target (user) to exercise an authority of the second target in place of the second target through the use of the first target (mobility).

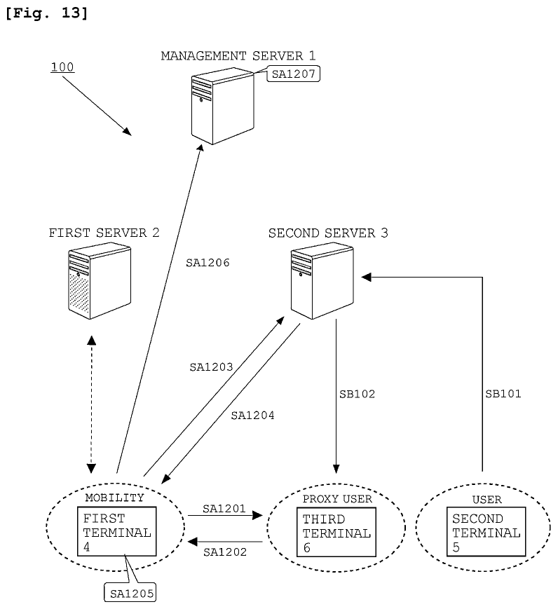

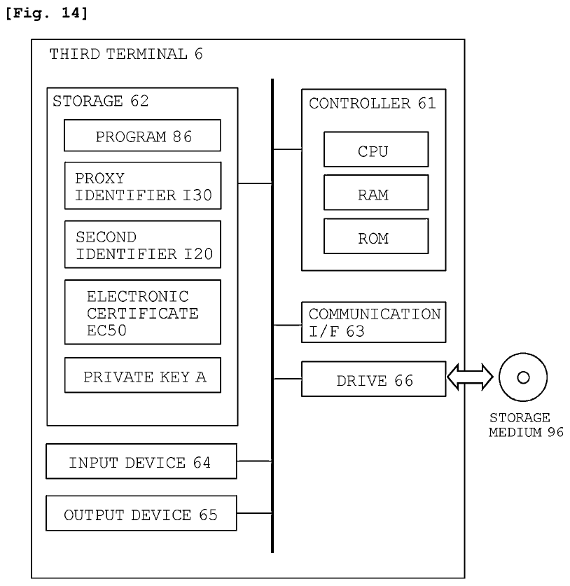

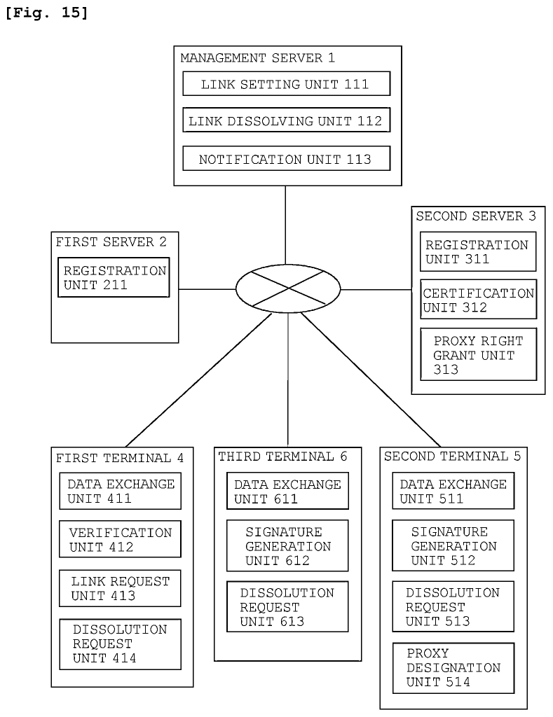

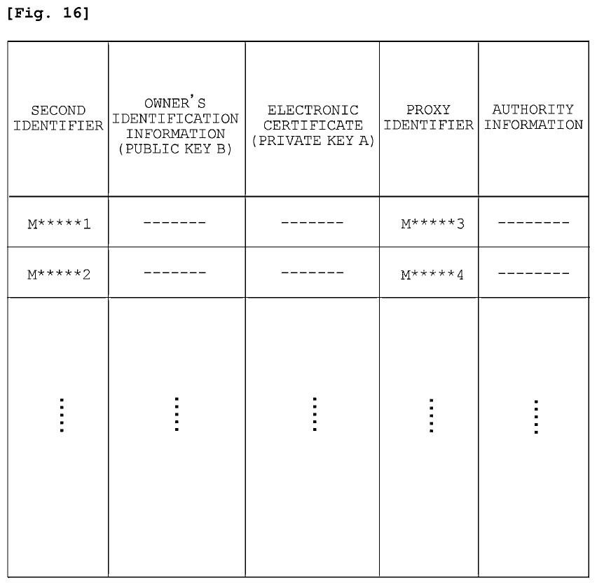

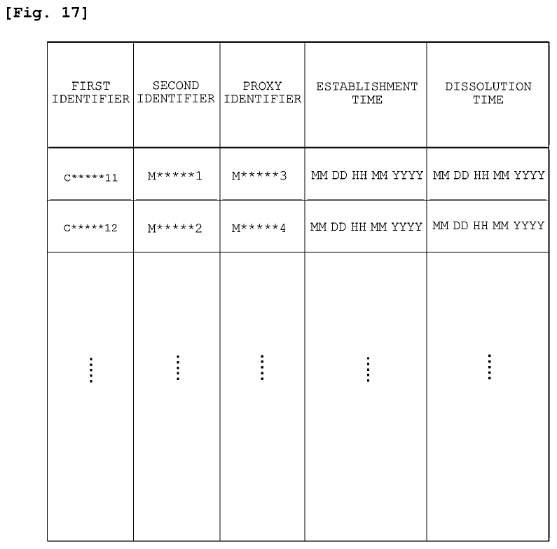

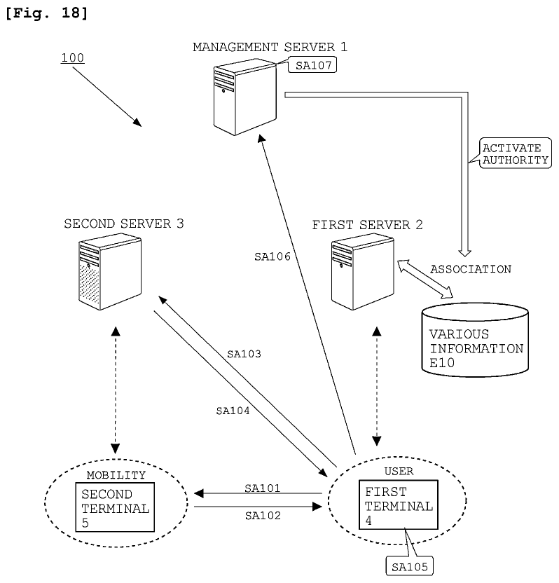

FIG. 13 is a diagram schematically illustrating an example situation where the management system 100 according to the present disclosure is applied. FIG. 14 is a diagram illustrating an example of the hardware configuration of a third terminal 6 used in the system according to the modification. FIG. 15 is a diagram illustrating an example of the software configuration of the apparatuses used in the system according to the modification, which include the management server 1, the first server 2, the second server 3, the first terminal 4, and the second terminal 5. FIG. 16 illustrates an example of the second target information D30 stored in the second server 3 according to the modification. FIG. 17 illustrate an example of the link information D10 stored in the management server 1 according to the modification.

In the example illustrated in FIG. 13, the second target grants the right of proxy to a proxy user at a certain time before a usage relationship between the first target and the proxy user is established. In a mode, the second target requests the second sever 3 to grant the right of proxy to the proxy user through the second terminal 5. In this case, as illustrated in FIG. 15, the second terminal 5 according to the modification operates as a computer that has a proxy designation unit 514 as a software module in addition to the data exchange unit 511, the signature generation unit 512, and the dissolution request unit 513. When the second terminal 5 requests the second server 3 to grant the right of proxy to the proxy user, the controller 51 of the second terminal 5 operates as the proxy designation unit 514. The proxy designation unit 514 sends the second identifier 120 of the second target, the owner's identification information of the second target, and a proxy identifier 130 of the proxy user to the second server 3 to request the second server 3 to grant the right of proxy to the proxy user (step SB101).

When the second server 3 receives the request to grant the right of proxy from the second terminal 5, it performs the certification of the second target and grants the right of proxy to the proxy user. In this case, as illustrated in FIG. 15, the second server 3 according to the modification operates as a computer that has a proxy right grant unit 313 as a software module in addition to the registration unit 311 and the certification unit 312. Thus, when the second server 3 receives a request to grant the right of proxy from the second terminal 5, the controller 31 of the second server 3 operates as the proxy right grant unit 313. The proxy right grant unit 313 verifies the validity of the second identifier 120 by verifying the owner's identification information of the second target contained in the request to grant the right of proxy with the owner's identification information that has already been registered in the second target information D30 stored in the storage 230, which is the owner's identification information registered with a link with the second identifier 120. If the verification of the owner's identification information of the second target contained in the request to grant the right of proxy with the owner's identification information already registered in the second target information D30 succeeds, the proxy right grant unit 313 determines that the second identifier 120 is valid.

When it is determined that the second identifier 120 of the second target is valid, the proxy right grant unit 313 set a correspondence relationship (Linking) between the second identifier 120 of the second target and the proxy identifier 130 of the proxy user. In a mode, the link may be set by recording the proxy identifier 130 in the second target information D30 associated with the second target. In this modification, as illustrated in FIG. 16, the second target information D30 may include the electronic certificate EC50 of the second target and the proxy identifier 130 of the proxy user in addition to the second identifier 120, the owner's identification information, and the authority information. The second target information D30 may further include the private key A of the second target.

After setting a correspondence relationship between the second identifier 120 of the second target and the proxy identifier 130 of the proxy user, the proxy right grant unit 313 grants the right of proxy for the second user to the proxy user (step SB102). In a mode, the proxy right grant unit 313 sends the second identifier 120 of the second target, the electronic certificate EC50 of the second target, and the private key A of the second target to the third terminal 6 (corresponding to the “proxy user's terminal” according to the present disclosure) that is used by the proxy user to grant the right of proxy for the second target to the proxy user (the third terminal 6). The electronic certificate EC50 and the private key A of the second target may be directly provided from the second terminal 5 to the third terminal 6 after the grant of the right of proxy to the proxy user.

When a usage relationship is established between the first target and the proxy user (the third terminal 6) while the proxy user has the right of proxy for the second target, data exchange is performed between the first terminal 4 and the third terminal 6. In a mode, the first terminal 4 firstly provides electronic information to the third terminal 6 (step SA1201). Then, upon receiving the electronic information provided from the first terminal 4, the third terminal 6 generates an electronic signature A of the proxy user. The third terminal 6 provides the generated electronic signature A to the first terminal 4 with the second identifier 120, the electronic certificate EC50, and the proxy identifier 130 (step S1202).

As illustrated in FIG. 14, the third terminal 6 according to the modification is a computer that has a controller 61, a storage 62, a communication interface 63, an input device 64, an output device 65, and a drive 66, which are electrically interconnected. The controller 61, the storage 62, the communication interface 63, the input device 64, the output device 65, the drive 66, and a storage medium 96 of the third terminal 6 may respectively be configured in the same manner as the controller 51, the storage 52, the communication interface 53, the input device 54, the output device 55, the drive 56, and a storage medium 95 of the second terminal 5. The storage 62 of the third terminal 6 is configured to store various information including a program 86, the proxy identifier 130 of the proxy user, the second identifier 120 of the second target, the electronic certificate EC50 of the second target, and the private key A of the second target. The second identifier 120 of the second target, the electronic certificate EC50 of the second target, and the private key A of the second target are provided from the second server 3 when the right of proxy for the second target was granted to the proxy user in step SB102.

As illustrated in FIG. 15, the third terminal 6 with the hardware configuration illustrated in FIG. 14 operates as a computer that has a data exchange unit 611, a signature generation unit 612, and a dissolution request unit 613 as software modules. The third terminal 6 implements the data exchange unit 611, the signature generation unit 612, and the dissolution request unit 613 by executing commands of the program 86 stored in the storage 62 by the controller 61.

In the third terminal 6 having the software modules illustrated in FIG. 15, the controller 61 operates as the data exchange unit 611 to receive the electronic information provided from the first terminal 4 in step SA1201 in FIG. 13. Then, the controller 61 of the third terminal 6 operates as the signature generation unit 612 to generate an electronic signature A of the second target. The method of generating the electronic signature A may be the same as that in the operational example described above. Specifically, the signature generation unit 612 firstly generates specific information that contains the electronic information provided from the first terminal 4 and the second identifier 120 stored in the storage 62. Then, the signature generation unit 612 encrypts the specific information generated as above using the private key A of the second target stored in the storage 62 to generate the electronic signature A of the second target.

After the electronic signature A of the second target is generated, the controller 61 of the third terminal 6 operates as the data exchange unit 611 to provide the generated electronic signature A, the second identifier 120 of the second target stored in the storage 62, the electronic certificate EC50 of the second target stored in the storage 62, and the proxy identifier 130 of the proxy user stored in the storage 62 to the first terminal 4. Then, the controller 41 of the first terminal 4 operates as the data exchange unit 411 to receive the electronic signature A, the second identifier 120, the electronic certificate EC50, and the proxy identifier 130 provided from the third terminal 6.

Upon receiving the electronic signature A, the second identifier 120, the electronic certificate EC50, and the proxy identifier 130, the controller 41 of the first terminal 4 operates as the verification unit 412 to send the second identifier 120, the electronic certificate EC50, and the proxy identifier 130 provided from the third terminal 6 to the second server 3 to request the second server 3 to verify the validity of the second identifier 120, the electronic certificate EC50, and the proxy identifier 130 (step SA1203).

When the second server 3 receives the verification request sent from the first terminal 4 through the communication interface 33, the controller 31 of the second server 3 operates as the certification unit 312 to execute the processing of verifying the validity of the second identifier 120, the electronic certificate EC50, and the proxy identifier 130 received from the first terminal 4. The verification of the validity of the second identifier 120 and the electronic certificate EC50 may be performed in the same manner as in the operational example described above. In a mode, to verify the validity of the proxy identifier 130, the certification unit 312 firstly accesses the second target information D30 stored in the storage 32 using the second identifier 120 as an argument to find the proxy identifier that is already registered in the second target information D30 with its link with the second identifier 120. Then, the certification unit 312 verifies the proxy identifier 130 sent from the first terminal 4 with the proxy identifier already registered in the second target information D30. If the verification of the proxy identifier 130 sent from the first terminal 4 with the proxy identifier already registered in the second target information D30 succeeds, the certification unit 312 determines that the proxy identifier 130 is valid.

If the verification of the validity of the second identifier 120, the electronic certificate EC50, and the proxy identifier 130 succeeds, the certification unit 312 sends the result of the verification (i.e., the success of the verification) to the first terminal 4 through the communication interface 33 (step SA1204). In this modification, the second server 3 that performs the above verification process corresponds to the “external server” according to the present disclosure.

When the first terminal 4 receives the verification result sent from the second server 3 through the communication interface, the controller 41 of the first terminal 4 operates as the verification unit 412 to verify the validity of the electronic signature A provided from the third terminal 6 (step SA1205). The verification of the validity of the electronic signature A may be carried out in the same manner as in the operational example described above.

If the verification of the validity of the second identifier 120, the electronic certificate EC50, and the electronic signature A succeeds, the controller 41 of the first terminal 4 operates as the link request unit 413 to request the management server 1 to set a correspondence relationship between the first target and the proxy user (step SA1206). In a mode, the link request unit 413 sends a link request containing the first identifier I10, the second identifier 120, and the proxy identifier 130 to the management server 1 through the communication interface 43.

When the management server 1 receives the link request sent from the first terminal 4 through the communication interface 13, the controller 11 of the management server 1 operates as the link setting unit 111 to execute the link processing (step SA1207). In a mode, the link setting unit 111 generates link information D10 for linking the first identifier I10, the second identifier 120, and the proxy identifier 130 and stores the generated link information D10 in the storage 12.

In a mode, as illustrated in FIG. 17, the link information D10 according to the modification may contain the first identifier I10, the second identifier 120, the proxy identifier 130, the establishment time, and the dissolution time. The establishment time refers to the time when a correspondence relationship between the first target and the proxy user was established. The establishment time may be a time stamp. The dissolution time refers to the time when the association between the first target and the proxy user is dissolved. The value of the dissolution time may be added when the processing of dissolving the association is executed. The way of indicating the dissolution is not limited to this. In another mode, the dissolution time may be replaced by at least one of the expiration time and a flag. The expiration time refers to the time until when the established correspondence relationship is valid. Then, whether the established correspondence relationship is valid or not (in other words, whether the association is still present or has been dissolved) is indicated by whether the current time is before the expiration time or not. The flag indicates whether the association has been dissolved or not. The flag may be set when the processing of dissolving the association is executed. In still another mode, the link information D10 may contain at least one of the expiration time and the flag in addition to the dissolution time field. The structure of the link information D10 is not limited to the structure illustrated in FIG. 17, but may be changed appropriately depending on the mode of implementation, on condition that it is able to indicate the state of the set correspondence relationship. In another mode, the link information D10 may contain information indicating the type of the used target (whether it is a target that is used on a full-time basis or a use target that is used on a temporary basis). The types of the used target are not necessarily required to be distinguished by separate information. For example, the types of the used target may be distinguished by other information such as the identifiers.

In step SB101 in FIG. 13, the proxy designation unit 514 may specify at least one of the expiration time of the right of proxy and the authority that the proxy user is allowed to exercise (effective authority) with the designation of the proxy user. Then, the proxy designation unit 514 may generate specification information configured to specify at least one of the specified expiration time and the effective authority. The specification information of at least one of the specified expiration time and the effective authority may be managed in any appropriate manner. In a mode, the specification information may be sent from the second terminal 5 to the second server 3 and managed in the second server 3 in association with the second target information D30. In the case where at least one of the expiration time of the right of proxy and the authority that the proxy user is allowed to exercise is specified, the right of proxy granted to the proxy user may expire when the specified expiration time arrives. Furthermore, the right of proxy granted to the proxy user may expire when the specified effective authority is exercised.

According to the first modification, the proxy user is allowed to exercise the authority of the user (second target) in place of the user through the use of the mobility. This increases the expandability of the exercise of the authority with assured security. For example, let us consider a case where the authority information includes information related to an electronic prescription and the authority is the authority to receive a medicine prescribed by the electronic prescription. In this case, if the user (second target) grants the right of proxy to a proxy user such as a member of his or her family, the proxy user can receive the medicine prescribed for the user (second target) through the use of the mobility.

### Second Modification

While in the case of the operational example described above the first target is a mobility and the second target is a user, the first target can be a user and the second target can be a mobility, as illustrated in FIG. 17. In this case, the first terminal 4 may by a user's terminal used by the user as the first target, and the second terminal 5 may be an on-board terminal provided on the mobility. Then, the first server 2 may be configured to perform the certification of the user as the first target, and the second server 3 may be configured to perform the certification of the mobility as the second target.

### Others

The processes and features described in the present disclosure may be adopted in any combination, if it is technically feasible to do so.

One or more of the processes that have been described as processes performed by one apparatus may be performed by a plurality of apparatuses in a distributed manner. One or more of the processes that have been described as processes performed by different apparatuses may be performed by one apparatus. The hardware configuration used to implement various functions in a computer system may be modified flexibly.

The technology disclosed herein can be implemented by supplying a computer program or programs configured to implement the functions described in the above description of the embodiments to a computer to cause one or more processors of the computer to read out and to execute the program or programs. Such a computer program or programs may be supplied to the computer by a non-transitory, computer-readable storage medium that can be connected to a system bus of the computer or through a network. Examples of the non-transitory, computer-readable storage medium include any type of discs including magnetic discs such as a floppy disc (registered trademark) and a hard disk drive (HDD), optical discs such as a CD-ROM, a DVD, and a Blu-ray disc, a read-only memory (ROM), a random access memory (RAM), an EPROM, an EEPROM, a magnetic card, a flash memory, an optical card, an semiconductor drive such as a solid state drive, and any type of media capable of storing electronic commands.

What is claimed is:

1. A terminal associated with a first target that is one of a mobility and a user, comprising a controller including at least one processor, the controller being configured to execute the processing of:
providing electronic information to another terminal associated with a second target that is the other of the mobility and the user;
obtaining an electronic signature of the second target generated using the electronic information, an electronic certificate of the second target issued by a certificate authority, and an identifier of the second target from the other terminal;
verifying the validity of the obtained electronic certificate using a public key of the certificate authority;
verifying the validity of the obtained electronic signature using a public key of the second target contained in the electronic certificate; and
in response to the success of the verification of the validity of the electronic certificate and the electronic signature, sending a request to set a correspondence relationship between an identifier of the first target and an identifier of the second target to a management server.

2. The terminal according to claim 1, wherein the electronic signature of the second target is generated by encrypting specific information containing the electronic information and the identifier of the second target using a private key of the second target associated with the public key.

3. The terminal according to claim 2, wherein the electronic information is a random number generated by the controller.

4. The terminal according to claim 2, wherein verifying the validity of the electronic certificate comprises:
decrypting an electronic signature of the certificate authority contained in the electronic certificate using the public key of the certificate authority;
verifying the validity of the decrypted information of the electronic signature of the certificate authority using the public key of the second target and identification information of the second target contained in the electronic certificate; and
determining whether the electronic certificate is valid.

5. The terminal according to claim 2, wherein
the first target is the mobility,
the terminal associated with the first target is an on-board terminal provided on the mobility,
the second target is the user, and
the other terminal associated with the second target is a proxy user's terminal used by a proxy user for the user.

6. The terminal according to claim 5, wherein verifying the validity of the electronic certificate comprises verifying the validity of the right of proxy of the proxy user in addition to verifying the validity of the obtained electronic certificate using the public key of the certificate authority.

7. The terminal according to claim 6, wherein verifying the validity of the right of proxy of the proxy user comprises:
sending a verification request containing the identifier of the user and an identifier of the proxy user to an external server that manages information related to the proxy user who has been granted the right of proxy by the user; and
receiving the result of the validity verification of the right of proxy of the proxy user from the external server.

8. An information processing method comprising the following processing performed by a terminal associated with a first target that is one of a mobility and a user:
providing electronic information to another terminal associated with a second target that is the other of the mobility and the user;
obtaining an electronic signature of the second target generated using the electronic information, an electronic certificate of the second target issued by a certificate authority, and an identifier of the second target from the other terminal;
verifying the validity of the obtained electronic certificate using a public key of the certificate authority;
verifying the validity of the obtained electronic signature using a public key of the second target contained in the electronic certificate; and
in response to the success of the verification of the validity of the electronic certificate and the electronic signature, sending a request to set a correspondence relationship between an identifier of the first target and the identifier of the second target to a management server.

9. The information processing method according to claim 8, wherein the electronic signature of the second target is generated by encrypting specific information containing the electronic information and the identifier of the second target using a private key of the second target associated with the public key.

10. The information processing method according to claim 9, wherein the electronic information is a random number.

11. The information processing method according to claim 9, wherein verifying the validity of the electronic certificate comprises:
decrypting an electronic signature of the certificate authority contained in the electronic certificate using the public key of the certificate authority;
verifying the validity of the decrypted information of the electronic signature of the certificate authority using the public key of the second target and identification information of the second target contained in the electronic certificate; and
determining whether the electronic certificate is valid.

12. The information processing method according to claim 9, wherein
the first target is the mobility,
the terminal associated with the first target is an on-board terminal provided on the mobility,
the second target is the user, and
the other terminal associated with the second target is a proxy user's terminal used by a proxy user for the user.

13. The information processing method according to claim 12, wherein verifying the validity of the electronic certificate comprises verifying the validity of the right of proxy of the proxy user in addition to verifying the validity of the obtained electronic certificate using the public key of the certificate authority.

14. The information processing method according to claim 13, wherein verifying the validity of the right of proxy of the proxy user comprises:
sending a verification request containing the identifier of the user and an identifier of the proxy user to an external server that manages information related to the proxy user who has been granted the right of proxy by the user; and
receiving the result of the validity verification of the right of proxy of the proxy user from the external server.

15. A non-transitory storage medium storing a program configured to cause a terminal associated with a first target that is one of a mobility and a user to execute the processing of:
providing electronic information to another terminal associated with a second target that is the other of the mobility and the user;
obtaining an electronic signature of the second target generated using the electronic information, an electronic certificate of the second target issued by a certificate authority, and an identifier of the second target from the other terminal;
verifying the validity of the obtained electronic certificate using a public key of the certificate authority;
verifying the validity of the obtained electronic signature using a public key of the second target contained in the electronic certificate; and
in response to the success of the verification of the validity of the electronic certificate and the electronic signature, sending a request to set a correspondence relationship between an identifier of the first target and the identifier of the second target to a management server.

16. The non-transitory storage medium according to claim 15, wherein the electronic signature of the second target is generated by encrypting specific information containing the electronic information and the identifier of the second target using a private key of the second target associated with the public key.

17. The non-transitory storage medium according to claim 16, wherein the electronic information is a random number.

18. The non-transitory storage medium according to claim 16, wherein verifying the validity of the electronic certificate comprises:
decrypting an electronic signature of the certificate authority contained in the electronic certificate using the public key of the certificate authority;
verifying the validity of the decrypted information of the electronic signature of the certificate authority using the public key of the second target and identification information of the second target contained in the electronic certificate; and
determining whether the electronic certificate is valid.

19. The non-transitory storage medium according to claim 16, wherein
the first target is the mobility,
the terminal associated with the first target is an on-board terminal provided on the mobility,
the second target is the user, and
the other terminal associated with the second target is a proxy user's terminal used by a proxy user for the user.

20. The non-transitory storage medium according to claim 19, wherein verifying the validity of the electronic certificate comprises verifying the validity of the right of proxy of the proxy user in addition to verifying the validity of the obtained electronic certificate using the public key of the certificate authority.
